(19) United States
(12) Patent Application Publication
(10) Pub. No.: US 2017/0301912 A1
(43) Pub. Date: Oct. 19, 2017

(54) LITHIUM ION SECONDARY BATTERY AND ANODE FOR LITHIUM ION SECONDARY BATTERY

(71) Applicant: Sony Corporation, Tokyo (JP)

(72) Inventors: Takakazu Hirose, Fukushima (JP); Motoki Endo, Fukushima (JP); Kenichi Kawase, Fukushima (JP); Tadahiko Kubota, Kanagawa (JP)

(21) Appl. No.: 15/638,458

(22) Filed: Jun. 30, 2017

Related U.S. Application Data
(63) Continuation of application No. 13/006,774, filed on Jan. 14, 2011.

(30) Foreign Application Priority Data
Jan. 27, 2010 (JP) 2010-015738

(51) Int. Cl. H01M 4/134; H01M 4/62; H01M 10/052

(52) U.S. Cl. CPC H01M 4/134; H01M 4/626; H01M 4/624; H01M 10/052

(57) ABSTRACT

There is provided a lithium ion secondary battery including: a cathode; an anode: and an electrolytic solution. The anode has an anode active material layer on an anode current collector, the anode active material layer contains an anode active material having silicon (Si) as an element and a metal conductive material having a metal element as an element, and a void ratio of the anode active material layer measured by mercury intrusion method (pressure: 90 MPa) is 10% or less.

### RELATED APPLICATION DATA

This application is a continuation of U.S. patent application Ser. No. 13/006,774 filed Jan. 14, 2011, the entirety of which is incorporated herein by reference to the extent permitted by law. The present application claims the benefit of priority to Japanese Patent Application No. JP 2010-015738 filed on Jan. 27, 2010 in the Japan Patent Office, the entirety of which is incorporated by reference herein to the extent permitted by law.

### BACKGROUND OF THE INVENTION

### 1. Field of the Invention

The present invention relates to an anode for a lithium ion secondary battery that includes an anode active material layer containing an anode active material and a metal conductive material and a lithium ion secondary battery using the same.

### 2. Description of the Related Art

In recent years, small electronic devices represented by a video camera, a digital still camera, a mobile phone, a notebook personal computer or the like have been widely used, and it is strongly demanded to reduce their size and weight and to achieve their long life. Accordingly, as a power source for the small electronic devices, a battery, in particular, a small and light-weight secondary battery capable of providing a high energy density has been developed. In recent years, it has been considered to apply such a secondary battery not only to the small electronic devices but also to large electronic devices represented by a battery car or the like.

Specially, a lithium ion secondary battery using insertion and extraction of lithium ions for charge and discharge reaction is largely prospective, since such a lithium ion secondary battery is able to provide a higher energy density than a lead battery and a nickel cadmium battery. The lithium ion secondary battery includes a cathode, an anode, and an electrolytic solution. The anode has an anode active material layer on an anode current collector. The anode active material layer contains an anode active material related to charge and discharge reaction.

As the anode active material, a carbon material is widely used. However, in recent years, since further improvement of the battery capacity is demanded, using silicon has been considered. Since the theoretical capacity of silicon (4199 mAh/g) is significantly higher than the theoretical capacity of graphite (372 mAh/g), it is prospected that the battery capacity is thereby highly improved. In this case, it has been considered to use an alloy, a compound or the like of silicon in addition to silicon simple substance.

For the structure of the anode in the lithium ion secondary battery, various studies have been made in order to improve the cycle characteristics and the like.

Specifically, an alloy layer or a composite oxide layer that contains a metal forming an alloy with lithium (tin (Sn) or the like) and a metal not forming an alloy with lithium (copper (Cu) or the like) is formed (for example, refer to Japanese Unexamined Patent Application Publication No. 2003-217574). Elements of Group 3A to Group 7A, Group 8, Group 1B, and Group 2B in Periods 4 to 6 (except for copper) are contained in at least the surface of a thin film on which silicon is deposited (for example, refer to Japanese Unexamined Patent Application Publication No. 2003-007295). A surface coating layer made of conductive material (copper or the like) with low ability of forming a lithium compound is formed on an active material layer made of a silicon material (mixed material of silicon and a metal or the like) (for example, refer to Japanese Unexamined Patent Application Publication No. 2004-228059). The second layer made of a lithium insertion material (silicon or the like) capable of forming an alloy with lithium is formed on the first layer (copper or the like) (for example, refer to Japanese Unexamined Patent Application Publication No. 2004-039407). In these cases, the layer containing silicon is formed by evaporation method, sputtering method, Chemical Vapor Deposition (CVD) method, plating method or the like.

Further, a coating section composed of a metal oxide (titanium oxide (TiO₂) or the like) is provided on the surface of a reaction section (silicon or the like) (for example, refer to Japanese Unexamined Patent Application Publication No. 2007-141666). In this case, the coating section is formed by liquid-phase precipitation method.

Further, silicon and a ferromagnetic metal element (iron (Fe) or the like) are contained in the anode active material layer (for example, refer to Japanese Unexamined Patent Application Publication No. 2007-257866). In this case, silicon and the ferromagnetic metal element are co-evaporated. Thereby, at least part of the ferromagnetic metal element is not solid-dispersed in silicon but is segregated, and the maximum magnetization of the anode active material layer obtained by magnetization curve is 0.0006 T or more.

Further, a metal element (iron or the like) is contained in the anode active material layer containing silicon so that the concentration thereof is increased and decreased in the thickness direction (for example, refer to Japanese Unexamined Patent Application Publication No. 2007-257868). In this case, a silicon layer and a metal layer are alternately formed by evaporation method.

In addition, particle surface of an anode active material is coated with a metal material (copper or the like) with low ability of forming a lithium compound to obtain void ratio of the anode active material layer from 15% to 45% both inclusive (for example, refer to Japanese Unexamined Patent Application Publication No. 2008-066278). In this case, after the anode current collector is coated with slurry containing the particle of the anode active material, infiltration and plating of the metal material is performed by electrolytic plating method.

### SUMMARY OF THE INVENTION

In these years, the high performance and the multi functions of the electronic devices are developed, and usage frequency thereof is increased. Thus, the lithium ion secondary battery tends to be frequently charged and discharged. Accordingly, decomposition reaction of the electrolytic solution and gas generation in the battery caused by the decomposition reaction of the electrolytic solution are easily generated continuously. Thus, as charge and discharge are repeated, the discharge capacity is decreased and battery swollenness tends to be generated.

In view of the foregoing disadvantages, in the invention, it is desirable to provide an anode for a lithium ion secondary battery capable of improving the cycle characteristics and the swollenness characteristics and a lithium ion secondary battery.

According to an embodiment of the invention, there is provided an anode for a lithium ion secondary battery having an anode active material layer on an anode current collector. The anode active material layer contains an anode active material having silicon as an element and a metal conductive material having a metal element as an element. A void ratio of the anode active material layer measured by mercury intrusion method (pressure: 90 MPa) is 10% or less. Further, according to an embodiment of the invention, there is provided a lithium ion secondary battery including a cathode, an anode, and an electrolytic solution, wherein the anode has a structure similar to that of the foregoing anode for a lithium ion secondary battery.

The void ratio is measured by a mercury porosimeter. Details for the mercury intrusion method are based on JIS R 1655.

According to the anode for a lithium ion secondary battery of the embodiment of the invention, the anode active material layer contains the anode active material having silicon as an element and the metal conductive material having the metal element as an element. The void ratio of the anode active material layer measured by mercury intrusion method (pressure: 90 MPa) is 10% or less. Thereby the surface area of the anode active material layer (reaction area) is significantly decreased, and thus reactivity is largely decreased. Therefore, according to the lithium ion secondary battery using the anode for a lithium ion secondary battery of the embodiment of the invention, decomposition reaction of the electrolytic solution and gas generation in the battery caused by the decomposition reaction of the electrolytic solution are inhibited. Therefore, the cycle characteristics and the swollenness characteristics are able to be improved.

Other and further objects, features and advantages of the invention will appear more fully from the following description.

### BRIEF DESCRIPTION OF THE DRAWINGS

FIG. 1 is a cross sectional view illustrating a structure of an anode for a lithium ion secondary battery according to an embodiment of the invention.

FIG. 2 is a scanning electron microscope (SEM) photograph illustrating a cross sectional structure of the anode for a lithium ion secondary battery of the invention.

FIG. 3 is an SEM photograph illustrating a cross sectional structure of an anode for a lithium ion secondary battery of a comparative example.

FIG. 4 is a cross sectional view illustrating a structure of a square type secondary battery using the anode for a lithium ion secondary battery of the embodiment of the invention.

FIG. 5 is a cross sectional view taken along line V-V of the square type secondary battery illustrated in FIG. 4.

FIG. 6 is a plan view schematically illustrating structures of the cathode and the anode illustrated in FIG. 4.

FIG. 7 is a cross sectional view illustrating a structure of a cylindrical type secondary battery using the anode for a lithium ion secondary battery of the embodiment of the invention.

FIG. 8 is a cross sectional view illustrating an enlarged part of the wound electrode body illustrated in FIG. 7.

FIG. 9 is an exploded perspective view illustrating a structure of a laminated film type secondary battery using the anode for a lithium ion secondary battery of the embodiment of the invention.

FIG. 10 is a cross sectional view taken along line X-X of the wound electrode body illustrated in FIG. 9.

FIG. 11 is a diagram illustrating a measurement result by a mercury porosimeter.

### DETAILED DESCRIPTION OF THE PREFERRED EMBODIMENT

An embodiment of the invention will be hereinafter described in detail with reference to the drawings. The description will be given in the following order.

1. Anode for a lithium ion secondary battery
2. Lithium ion secondary battery
2-1. Square type
2-2. Cylindrical type
2-3. Laminated film type

1. Anode for a Lithium Ion Secondary Battery

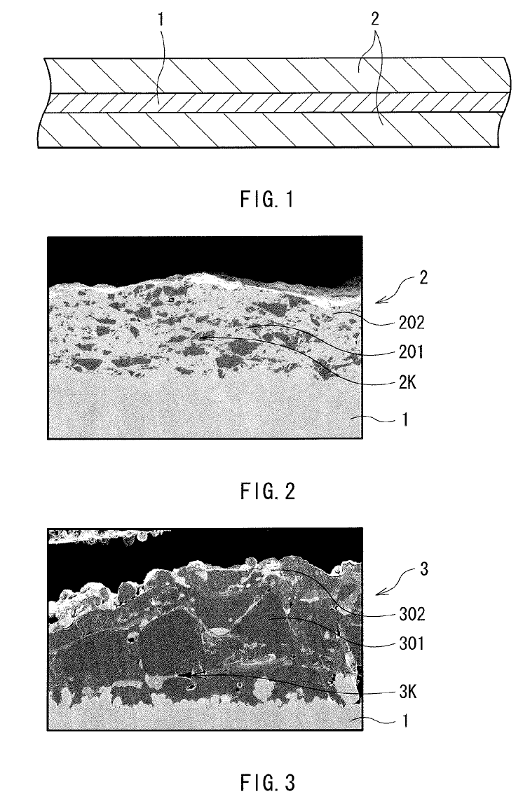

FIG. 1 illustrates a cross sectional structure of an anode for a lithium ion secondary battery according to an embodiment of the invention (hereinafter simply referred to as “anode”).

Whole Structure of the Anode

The anode has an anode active material layer 2 on an anode current collector 1. The anode active material layer 2 may be provided on both faces of the anode current collector 1, or may be provided only on a single face of the anode current collector 1.

Anode Current Collector

The anode current collector 1 is, for example, made of a conductive material having superior electrochemical stability, superior electric conductivity, and superior mechanical strength. Examples of such a conductive material include copper, nickel (Ni), and stainless steel. In particular, a material that does not form an intermetallic compound with lithium (Li) and that is alloyed with the anode active material layer 2 is preferable.

It is possible that the surface of the anode current collector 1 is not roughened or is roughened. Examples of roughening methods include electrolytic treatment and sandblast treatment. The electrolytic treatment is a method of providing a surface with concavity and convexity by forming fine particles on the surface of a metal foil or the like by electrolytic method in an electrolytic bath. A copper foil formed by the electrolytic method is generally called an electrolytic copper foil.

The surface roughness (ten point height of roughness profile Rz) of the anode current collector 1 is not particularly limited for the following reason. That is, since the contact characteristics between the anode current collector 1 and the anode active material layer 2 are sufficiently high in the invention as described later, the contact characteristics are hardly affected by the surface roughness. Specially, the ten point height of roughness profile Rz is preferably 2 μm or less, and is more preferably 1 μm or less, since thereby the contact characteristics between the anode current collector 1 and the anode active material layer 2 are more improved.

Anode Active Material Layer

The anode active material layer 2 contains an anode active material and a metal conductive material. If necessary, the anode active material layer 2 may further contain other material such as an anode binder and an anode electrical conductor.

The anode active material layer 2 contains, as an anode active material, one or more anode materials capable of inserting and extracting lithium ions.

The anode material has silicon as an element, since silicon has superior ability to insert and extract lithium ions and thus is able to provide a high energy density. Examples of such an anode material include a simple substance, an alloy, or a compound of silicon. The anode material may be a mixture of two or more thereof, or may be a material having one or more phases thereof at least in part.

“Simple substance” in the invention absolutely means the general simple substance (a slightest amount of impurity may be contained), but does not necessarily mean 100% pure substance. Further, “alloys” in the invention include a material having one or more metal elements and one or more metalloid elements as an element, in addition to a material having two or more metal elements as an element. It is needless to say that the “alloys” may have a nonmetallic element as an element. The structure thereof includes a solid solution, a eutectic crystal (eutectic mixture), an intermetallic compound, and a structure in which two or more thereof coexist.

Examples of alloys of silicon include a material having one or more of the following metal elements as an element other than silicon. That is, examples of the elements include iron, aluminum (Al), calcium (Ca), manganese (Mn), chromium (Cr), magnesium (Mg), nickel, potassium (K), copper, titanium (Ti), tin (Sn), cobalt (Co), zinc (Zn), indium (In), silver (Ag), germanium (Ge), bismuth (Bi), and antimony (Sb).

Examples of compounds of silicon include a material having oxygen (O) or carbon (C) as an element other than silicon. The compounds of silicon may have, for example, one or more of the foregoing elements described for the alloys of silicon as an element other than silicon.

Specially, the alloy of silicon is preferable, since the alloy of silicon has a metal element, resistance is decreased and binding characteristics (associativity) between the anode active material and the metal conductive material are improved. Specially, as a metal element, iron is preferable, since thereby favorable resistance and binding characteristics are able to be obtained. The alloy of silicon is formed by, for example, gas atomization method, water atomization method or the like. The content of the metal element in the alloy of silicon is not particularly limited, but in particular, is preferably 0.2 wt % or more, since thereby favorable resistance and binding characteristics are able to be obtained without losing silicon characteristics of capability of providing high energy density.

The anode active material may be crystalline or noncrystalline, but is preferably crystalline in particular, since thereby physical property of the anode active material is hardly deteriorated with age, and the anode active material layer 2 is hardly expanded and shrunk at the time of charge and discharge. Whether or not the anode active material is crystalline is able to be checked by, for example, X-ray diffraction method. Specifically, if a sharp peak is observed by X-ray diffraction, the anode active material is crystalline.

Specially, the half bandwidth (2θ) of the diffraction peak in (111) crystal plane of the anode active material obtained by X-ray diffraction method is preferably 20 degree or less, and is more preferably from 0.4 to 20 degree both inclusive. Further, the crystallite size originated in the (111) crystal plane of the anode active material obtained by X-ray diffraction method is preferably 10 nm or more, and is more preferably from 10 nm to 115 nm both inclusive. Thereby, crystallinity of the anode active material is increased, and thus diffusion characteristics of lithium ions are improved at the time of charge and discharge. Thereby, the anode active material layer 2 is hardly expanded and shrunk, and breakage (deformation, crack, dropping or the like) of the anode active material layer 2 hardly occurs resulting from such expansion and shrinkage of the anode active material layer 2.

The anode active material layer 2 preferably contains one or more metal materials as the anode conductive material.

The metal material contains, for example, one or more metal elements such as copper, nickel, cobalt, iron, zinc, aluminum, chromium, manganese, titanium, zirconium, molybdenum, tungsten, silver, indium, and tin. The metal material may be a simple substance of the foregoing metal elements, an alloy thereof, or a compound thereof. Examples of the alloy include a material having two or more out of the foregoing metal elements. Examples of the compound include a material having oxygen as an element other than the metal element.

Specially, the metal material is preferably a simple substance of the foregoing metal elements, since thereby biding characteristics of the metal conductive materials are improved. In particular, in the case where the anode active material is an alloy of silicon, if the metal element type contained in the alloy is the same type as that of the metal material, binding characteristics between the anode active material and the metal conductive material are further improved.

The average thickness of the metal conductive material is not particularly limited, but in particular, is preferably from 1 nm to 30000 nm both inclusive, since thereby each anode active material is easily bound with each other with the metal conductive material in between. The average thickness of the metal conductive material is measured as follows. First, the anode active material layer 2 is cut by using a cross section polisher or the like, and a cross section is exposed. Subsequently, a plurality of locations (for example, five or more locations) of the cross section of the anode active material layer 2 are observed with the use of SEM (for example, magnification ratio: 3000 magnifications) or the like. Subsequently, a vertical line (line vertical to the surface of the anode current collector 1) is drawn on the anode active material layer 2 for every SEM photograph. After the thickness of the metal conductive material crossing the vertical line (distance between each anode active material) is measured, the average value is calculated. In this case, the number of vertical lines is not limited to one, but two or more vertical lines may be drawn. Finally, the average value of the thickness of the metal conductive material (average value) obtained for every SEM photograph is calculated.

The void ratio of the anode active material layer 2 measured by mercury intrusion method (pressure: 90 MPa) is preferably 10% or less, and more preferably 7% or less. Since the surface area (reaction area) of the anode active material layer 2 is significantly decreased, reactivity is largely decreased. In measuring the void ratio, as described above, a mercury porosimeter is used, and measurement is based on JISR 1655.

As long as the void ratio is within the foregoing range, the pore diameter distribution of the void existing in the anode active material layer 2 is not particularly limited. Specially, it is preferable that the pore diameter does not concentrate on a specific value (one or more values), but is dispersed in a wide range, since thereby the surface area of the anode active material layer 2 is more decreased. Further, in this case, stress relaxation space in the anode active material layer 2 is widely dispersed, and thus even if the anode active material layer 2 is expanded and shrunk at the time of charge and discharge, the anode active material layer 2 is hardly broken.

The method of forming the anode active material layer 2 is not particularly limited as long as the void ratio is within the foregoing range. Specially, the anode active material layer 2 is preferably formed by depositing forming materials of the anode active material and the metal conductive material (the anode material and the metal material) on the surface of the anode current collector 1 by impact binding phenomenon in the same step. “Depositing in the same step” means that the anode material and the metal material are deposited at the same time in one step (while being mixed), differently from a case that the metal material is deposited after the anode material is deposited or a case that the anode material is deposited after the metal material is deposited. Thereby, in the anode active material layer 2, the anode active material and the metal conductive material are mixed at random. As long as the anode material and the metal material are deposited in the same step, the anode active material layer 2 may have a single layer structure or may have a multilayer structure.

The impact binding phenomenon is phenomenon that when particles of the anode material and the metal material are sprayed and hit to the anode current collector 1, these materials are contacted with the surface of the anode current collector by pulverization and deformation of the particles due to impact at the time of hitting not due to surface fusion caused by temperature increase of the materials. In this case, since the active effect by a new face formed at the time of pulverization dominantly works on binding between the particles, a dense film of the anode material and the metal material is formed on the surface of the anode current collector 1. The impact binding phenomenon is not associated with temperature increase practically as described above, and thus is also referred to as ambient temperature impact solidification phenomenon. Accordingly, deposition method by impact binding phenomenon is a film forming method by ambient temperature solidification.

Examples of deposition methods by the impact binding phenomenon include powder jet deposition (PJD) method and aerosol deposition (AD) method. However, as long as the method is a deposition method using the impact binding phenomenon, a method other than the foregoing methods may be used. For the details of the deposition methods by the impact binding phenomenon, for example, descriptions are given in the following documents:
1. “Success of forming a ceramics film at ambient temperature by nano-level particle pulverization,” National Institute of Advanced Industrial Science and Technology, AIST Today, August 2004, pp. 4-6
2. “Research and development of energy rationalization technology of ceramic industry process by using impact binding phenomenon” http://www.nedo.go.jp/iinkai/singi/shoene/3/7-2-2.pdf
3. “Development of double nozzle type powder jet deposition device” http://ilc.kek.jp/MechWS/2007/MW07-09Yoshihara.pdf

The anode material and the metal material are preferably deposited by impact binding phenomenon for the following reason. That is, in this case, the anode active material and the anode conductive material are more densely formed in the course of film formation than in a case that the anode material and the metal material are deposited by other method. Thus, in this case, as described above, the void ratio of the anode active material layer 2 is significantly small. The foregoing “other method” includes the following method or the like. In the case where the anode material and the metal material are formed in the same step, for example, evaporation method, sputtering method, spraying method or the like is used. Further, in the case where the anode material and the metal material are formed in each individual step, after the anode material is deposited by the foregoing evaporation method or the like, the metal material is deposited by electrolytic plating method, nonelectrolytic plating method or the like.

In the case where the anode material and the metal material are formed in the same step, the anode material and the metal material may be formed as an integral form, or may be formed as a separated form. The integral form means, for example, powder (particle) of the anode material with the surface previously coated with the metal material. The metal material is preferably formed by electrolytic plating method, nonelectrolytic plating method or the like, since thereby the surface of the anode active material is easily coated with the metal material. In addition, the integral form may be alloy powder composed of the anode material and the metal material. Meanwhile, the separated form is a powder mixture composed of anode material powder and metal material powder. Specially, the integral form is preferable, since the integral form is easily handled.

The median diameter of the anode material is not particularly limited, but in particular, is preferably from 0.1 μm to 10 μm both inclusive, since thereby the anode active material is densely formed, and is hardly cracked. More specifically, if the median diameter is smaller than 0.1 μm, the surface area of the anode active material layer 2 may be increased. Meanwhile, if the median diameter is larger than 10 μm, physical strength of the anode active material may be decreased, and large void may be generated in the anode active material layer 2.

One or both of the anode active material and the metal conductive material is preferably linked to the anode current collector 1. Thereby, the anode active material layer 2 is physically fixed on the anode current collector 1, and thus the anode active material layer 2 is hardly expanded and shrunk at the time of charge and discharge. As a result, the anode active material layer 2 is hardly broken. “One or both of the anode active material and the metal conductive material is linked to the anode current collector 1” means, as described above, that the anode material and the metal material are deposited on the surface of the anode current collector 1 by PJD method or the like. Thus, in the case where coating method or sintering method is used, the anode active material is not linked to the anode current collector 1. In this case, the anode active material is indirectly linked to the anode current collector 1 with other material (anode binder or the like) in between, or the anode active material is only adjacent to the surface of the anode current collector 1.

Specially, the anode active material and the metal conductive material are preferably alloyed with the anode current collector 1 in at least part of the interface thereof. Thereby, the anode active material layer 2 becomes still hardly expanded and shrunk. In this case, at the interface thereof, the element of the anode current collector may be diffused in the anode active material or the like, the element of the anode active material or the like may be diffused in the anode current collector 1, or these elements may be diffused in each other.

Examples of anode binders include one or more out of a synthetic rubber, a polymer material and the like. Examples of synthetic rubber include styrene butadiene rubber, fluorinated rubber, and ethylene propylene diene. Examples of polymer material include polyvinylidene fluoride and polyimide.

Examples of anode electrical conductors include one or more out of carbon materials such as graphite, carbon black, acetylene black, and Ketjen black. The anode electrical conductor may be a metal, a conductive polymer or the like as long as the material has the electric conductivity.

A description will be given of a detailed structure example of the anode. FIGS. 2 and 3 respectively illustrate SEM photographs (secondary electron images) illustrating cross sectional structures of the anode of the invention and an anode of a comparative example. The anode of the comparative example has an anode active material layer 3 instead of the anode active material layer 2.

In the invention, for example, the anode material and the metal material are deposited on the surface of the anode current collector 1 by impact binding phenomenon (PJD method) in the same step. Thereby, as illustrated in FIG. 2, in the anode active material layer 2, an anode active material 201 and a metal conductive material 202 are mixed and are densely distributed. In this case, almost no void 2K exists in the anode active material layer 2, and the pore diameter is significantly small. Thus, the void ratio measured by mercury intrusion method is kept 10% or less.

Meanwhile, in the comparative example, for example, after the anode material is deposited on the surface of the anode current collector 1 by spraying method, the metal material is deposited by electrolytic plating method. In this case, after a particulate anode active material 301 is formed, a plating film (metal conducive material 302) is grown in a gap between the anode active materials 301. The particulate anode active material 301 is approximately circular or planular. The anode active material 301 is observed in a state that the anode active material 301 has outline (outer rim) with which the particulate anode active material 301 is able to be visually checked. A space (gap) in which the anode material is not deposited is observed between the particulate anode active materials 301. Further, the metal conducive material 302 is observed in a state that the metal conducive material 302 exists in the foregoing gap. Thereby, a small capacity gap is sufficiently filled with the metal conducive material 302, but a large capacity gap is not sufficiently filled with the metal conducive material 302. In this case, as illustrated in FIG. 3, many voids 3K exist in the anode active material layer 3, and the pore diameter is significantly large. Thus, the void ratio measured by mercury intrusion method exceeds 10%.

Method of Manufacturing the Anode

The anode is manufactured, for example, by the following procedure. First, a mixed material (alloy powder) of the anode material and the metal material is prepared by gas atomization method, water atomization method or the like. The mixture ratio between the anode material and the metal material is voluntarily set. Subsequently, the mixed material is deposited on the surface of the anode current collector 1 by impact binding phenomenon, and thereby the anode active material layer 2 containing the anode active material and the metal conductive material is formed. Instead of the alloy powder, anode material powder with the surface coated with the metal material or a mixture of anode material powder and metal material powder may be used.

Action and Effect of this Embodiment

According to the anode, the anode active material layer 2 contains the anode active material (material having silicon as an element) and a metal conductive material (material having a metal element as an element). The void ratio of the anode active material layer 2 measured by mercury intrusion method (pressure: 10 MPa) is 10% or less. Thereby, the surface area (reaction area) of the anode active material layer 2 is significantly decreased, and thus reactivity is largely decreased. Thus, the anode of this embodiment is able to contribute to improvement of performance of the lithium ion secondary battery using the anode.

In particular, in the case where the void ratio of the anode active material layer 2 is 7% or less, the reactivity is more decreased, and thus higher effect is able to be obtained. Further, in the case where the forming materials of the anode active material and the metal conductive material (the anode material and the metal material) are deposited on the surface of the anode current collector 1 by impact binding phenomenon in the same step, the void ratio of the anode active material layer 2 is able to be kept small.

Further, in the case where the anode active material is crystalline, higher effect is able to be obtained. In this case, if the half bandwidth (2θ) of the diffraction peak in (111) crystal plane of the anode active material obtained by X-ray diffraction method is 20 degree or less and the crystallite size is 10 nm or more, higher effect is able to be obtained.

Further, if the ten point height of roughness profile Rz of the surface of the anode current collector 1 is 2 μm or less, or preferably 1 μm or less, higher effect is able to be obtained.

2. Lithium Ion Secondary Battery

Next, a description will be given of a lithium ion secondary battery using the foregoing anode for a lithium ion secondary battery.

2-1. Square Type

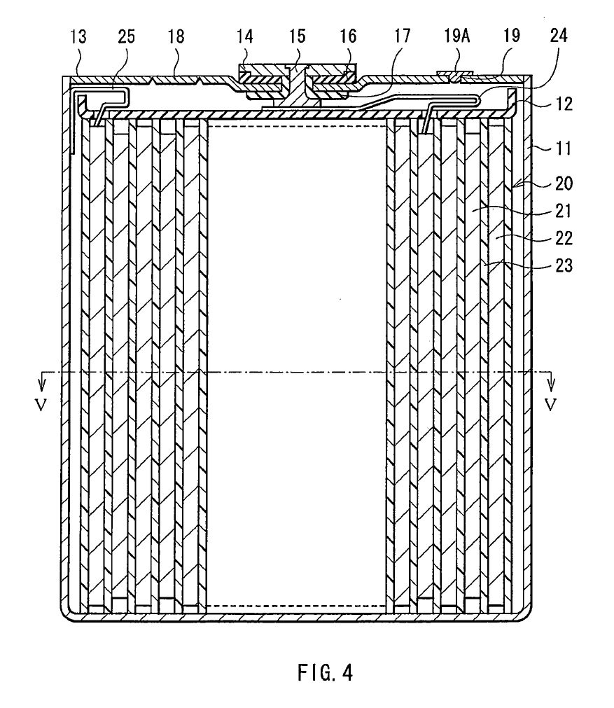

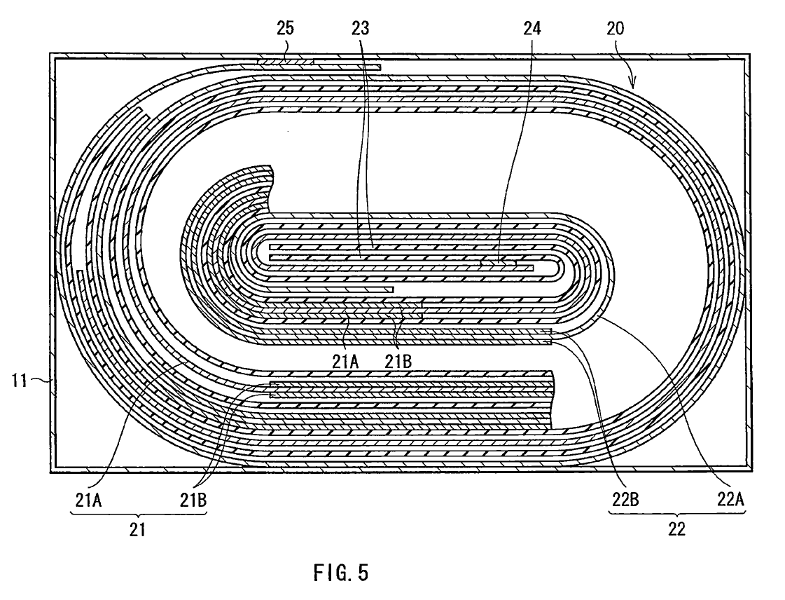

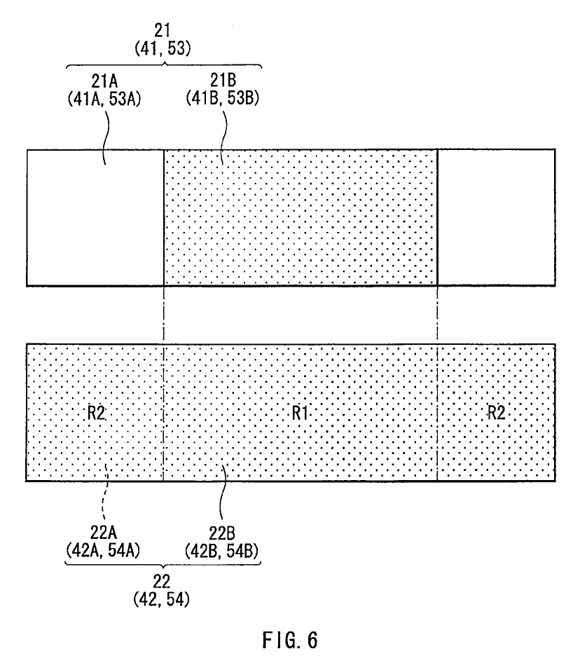

FIG. 4 and FIG. 5 illustrate cross sectional structures of a square type secondary battery. FIG. 5 illustrates a cross section taken along line V-V illustrated in FIG. 4. FIG. 6 illustrates a planar structure of a cathode 21 and an anode 22 illustrated in FIG. 5.

Whole Structure of the Square Type Secondary Battery

In the square type secondary battery, a battery element 20 is contained in a battery can 11 mainly. The battery element 20 is a wound laminated body in which the cathode 21 and the anode 22 are layered with a separator 23 in between and are spirally wound. The battery element 20 is planular according to the shape of the battery can 11.

The battery can 11 is, for example, a square type package member. As illustrated in FIG. 5, the square type package member has a shape with the cross section in the longitudinal direction of a rectangle or an approximate rectangle (including curved lines in part). The square type package member applies not only to a square type battery in the shape of a rectangle, but also to a square type battery in the shape of an oval. In other words, the square type package member means a rectangle vessel-like member with the bottom or an oval vessel-like member with the bottom, which respectively has an opening in the shape of a rectangle or in the shape of an approximate rectangle (oval shape) formed by connecting circular arcs by straight lines. FIG. 5 illustrates a case that the battery can 11 has a rectangular cross sectional shape.

The battery can 11 is made of, for example, a conductive material such as iron, aluminum, and an alloy thereof. In some cases, the battery can 11 has a function as an electrode terminal. Specially, to inhibit the battery can 11 from being swollen by using the rigidity (hardly deformable characteristics) of the battery can 11 at the time of charge and discharge, rigid iron is more preferable than aluminum. In the case where the battery can 11 is made of iron, the surface of the battery can 11 may be plated by nickel or the like.

Further, the battery can 11 has a hollow structure in which one end of the battery can 11 is opened and the other end of the battery can 11 is closed. At the open end of the battery can 11, an insulating plate 12 and a battery cover 13 are attached, and therefore inside of the battery can 11 is hermetically closed. The insulating plate 12 is provided between the battery element 20 and the battery cover 13, and is made of, for example, an insulating material such as polypropylene. The battery cover 13 is, for example, made of a material similar to that of the battery can 11, and may have a function as an electrode terminal as the battery can 11 does.

Outside of the battery cover 13, a terminal plate 14 as a cathode terminal is provided. The terminal plate 14 is electrically insulated from the battery cover 13 with an insulating case 16 in between. The insulating case 16 is made of, for example, an insulating material such as polybutylene terephthalate. In the approximate center of the battery cover 13, a through-hole is provided. A cathode pin 15 is inserted in the through-hole so that the cathode pin is electrically connected to the terminal plate 14 and is electrically insulated from the battery cover 13 with a gasket 17 in between. The gasket 17 is made of, for example, an insulating material, and the surface thereof is coated with, for example, asphalt.

In the vicinity of the rim of the battery cover 13, a cleavage valve 18 and an injection hole 19 are provided. The cleavage valve 18 is electrically connected to the battery cover 13. In the case where the internal pressure of the battery becomes a certain level or more by internal short circuit, external heating or the like, the cleavage valve 18 is separated from the battery cover 13 to release the internal pressure. The injection hole 19 is sealed by a sealing member 19A made of, for example, a stainless steel ball or the like.

A cathode lead 24 made of a conductive material such as aluminum is attached to an end of the cathode 21 (for example, the internal end thereof). An anode lead 25 made of a conductive material such as nickel is attached to an end of the anode 22 (for example, the outer end thereof). The cathode lead 24 is electrically connected to the terminal plate 14 by being welded to an end of the cathode pin 15. The anode lead 25 is welded and electrically connected to the battery can 11.

Cathode

The cathode 21 has, for example, a cathode active material layer 21B provided on both faces of a cathode current collector 21A. However, the cathode active material layer 21B may be provided only on a single face of the cathode current collector 21A.

The cathode current collector 21A is made of, for example, a conductive material such as aluminum, nickel, and stainless steel.

The cathode active material layer 21B contains, as a cathode active material, one or more cathode materials capable of inserting and extracting lithium ions. According to needs, the cathode active material layer 21B may contain other material such as a cathode binder and a cathode electrical conductor. Details of the cathode binder and the cathode electrical conductor are, for example, similar to those of the anode binder and the anode electrical conductor.

As the cathode material, a lithium-containing compound is preferable, since thereby a high energy density is able to be obtained. Examples of lithium-containing compounds include a composite oxide having lithium and a transition metal element as an element and a phosphate compound containing lithium and a transition metal element as an element. Specially, a material having one or more out of cobalt, nickel, manganese, and iron as a transition metal element is preferable, since thereby a higher voltage is obtained. The chemical formula thereof is expressed by, for example, LiₓM1O₂ or Li_{y}M2PO₄. In the formula, M1 and M2 represent one or more transition metal elements. Values of x and y vary according to the charge and discharge state, and are generally within the range of 0.05≦x≦1.10 and 0.05≦y≦1.10.

Examples of composite oxides having lithium and a transition metal element include a lithium-cobalt composite oxide (LiₓCoO₂), a lithium-nickel composite oxide (LiₓNiO₂), and a lithium-nickel composite oxide expressed by Formula (1). Examples of phosphate compounds having lithium and a transition metal element include lithium-iron phosphate compound (LiFePO₄) and a lithium-iron-manganese phosphate compound (LiFe₁₋ᵤMnᵤPO₄ (u<1)), since thereby a high battery capacity is obtained and superior cycle characteristics are obtained. The cathode material may be a material other than the foregoing material such as a material expressed by LiₓM1_{y}O₂ (M1 is one or more of metal elements (nickel and M shown in Formula 1 (cobalt or the like), x>1 is satisfied, and y is a given value).

LiNi₁₋ₓMₓO₂ Formula 1

In the formula, M is one or more of cobalt, manganese, iron, aluminum, vanadium, tin, magnesium, titanium, strontium, calcium, zirconium, molybdenum, technetium, ruthenium, tantalum, tungsten, rhenium, ytterbium, copper, zinc, barium, boron, chromium, silicon, gallium, phosphorus, antimony, and niobium. x is within the range of 0.005<x<0.5.

In addition, examples of cathode materials include an oxide, a disulfide, a chalcogenide, and a conductive polymer. Examples of oxide include titanium oxide, vanadium oxide, and manganese dioxide. Examples of disulfide include titanium disulfide and molybdenum sulfide. Examples of chalcogenide include niobium selenide. Examples of conductive polymer include sulfur, polyaniline, and polythiophene.

Anode

The anode 22 has a structure similar to that of the foregoing anode for a lithium ion secondary battery. The anode 22 has, for example, an anode active material layer 22B on both faces of an anode current collector 22A. Structures of the anode current collector 22A and the anode active material layer 22B are respectively similar to the structures of the anode current collector 1 and the anode active material layer 2. In the anode 22, the capacity chargeable in the anode material capable of inserting and extracting lithium ions is preferably larger than the discharge capacity of the cathode 21 in order to prevent unintentional precipitation of lithium metal at the time of charge and discharge.

As illustrated in FIG. 6, for example, the cathode active material layer 21B is provided on part of the surface of the cathode current collector 21A (for example, in the central region in the longitudinal direction). Meanwhile, the anode active material layer 22B is provided in a region wider than the forming region of the cathode active material layer 21B such as the whole surface of the anode current collector 22A. Thereby, the anode active material layer 22B is provided in a region opposed to the cathode active material layer 21B (opposed region R1) and in a region not opposed to the cathode active material layer 21B (non-opposed region R2) in the anode current collector 22A. In this case, out of the anode active material layer 22B, the section provided in the opposed region R1 contributes to charge and discharge, while the section provided in the non-opposed region R2 hardly contributes to charge and discharge. In FIG. 6, the cathode active material layer 21B and the anode active material layer 22B are shaded.

As described above, the anode active material layer 22B contains the anode active material and the metal conductive material formed by PJD method or the like. The void ratio of the anode active material layer 22B is kept 10% or less. However, in the case where the anode active material layer 22B is expanded and shrunk at the time of charge and discharge, the anode active material layer 22B is broken (for example, deformed) being affected by stress at the time of expansion and shrinkage. Thus, the void ratio value may be changed from the value immediately after forming the anode active material layer 22B. However, the non-opposed region R2 is hardly affected by charge and discharge reaction, and the state immediately after forming the anode active material layer 22B remains without change. Thus, it is preferable to examine the void ratio in the anode active material layer 22B in the non-opposed region R2, since thereby the void ratio, that is, the void ratio value immediately after forming the anode active material layer 22B is able to be accurately examined in a reproducible fashion without depending on charge and discharge history (presence, the number and the like of charge and discharge).

Separator

The separator 23 separates the cathode 21 from the anode 22, and passes lithium ions while preventing current short circuit resulting from contact of both electrodes. The separator 23 is formed from, for example, a porous film made of a synthetic resin or ceramics. The separator 23 may be a laminated film composed of two or more porous films. Examples of synthetic resin include polytetrafluoroethylene, polypropylene, and polyethylene.

Electrolytic Solution

An electrolytic solution as a liquid electrolyte is impregnated in the separator 23. The electrolytic solution contains a solvent and an electrolyte salt dissolved therein. The electrolytic solution may contain other material such as an additive according to needs.

The solvent contains, for example, one or more nonaqueous solvents such as an organic solvent. Examples of nonaqueous solvents include the following. That is, examples thereof include ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, and tetrahydrofuran. Further examples thereof include 2-methyltetrahydrofuran, tetrahydropyran, 1,3-dioxolane, 4-methyl-1,3-dioxolane, 1,3-dioxane, and 1,4-dioxane. Furthermore, examples thereof include methyl acetate, ethyl acetate, methyl propionate, ethyl propionate, methyl butyrate, methyl isobutyrate, trimethyl methyl acetate, and trimethyl ethyl acetate. Furthermore, examples thereof include acetonitrile, glutaronitrile, adiponitrile, methoxyacetonitrile, 3-methoxypropionitrile, N,N-dimethylformamide, N-methylpyrrolidinone, and N-methyloxazolidinone. Furthermore, examples thereof include N,N′-dimethylimidazolidinone, nitromethane, nitroethane, sulfolane, trimethyl phosphate, and dimethyl sulfoxide. In the case of using the foregoing material, superior battery capacity, superior cycle characteristics, and superior storage characteristics and the like are obtained.

Specially, one or more of ethylene carbonate, propylene carbonate, dimethyl carbonate, diethyl carbonate, and ethyl methyl carbonate is preferable, since thereby more superior characteristics are obtained. In this case, a combination of a high viscosity (high dielectric constant) solvent (for example, specific inductive ∈≧30) such as ethylene carbonate and propylene carbonate and a low viscosity solvent (for example, viscosity≦1 mPa·s) such as dimethyl carbonate, ethylmethyl carbonate, and diethyl carbonate is more preferable. Thereby, dissociation property of the electrolyte salt and ion mobility is improved.

In particular, the solvent preferably contains one or more of a halogenated chain ester carbonate and a halogenated cyclic ester carbonate. Thereby, a stable coat is formed on the surface of the anode 22 at the time of charge and discharge, and decomposition of the electrolytic solution is inhibited. The halogenated chain ester carbonate is a chain ester carbonate having halogen as an element (one or more hydrogen is substituted with halogen). Further, the halogenated cyclic ester carbonate is a cyclic ester carbonate having halogen as an element (one or more hydrogen is substituted with halogen).

The halogen type is not particularly limited, but specially, fluorine (F), chlorine (CO, or bromine (Br) is preferable, and fluorine is more preferable since thereby higher effect is obtained compared to other halogen. The number of halogen is more preferably two than one, and further may be three or more, since thereby an ability to form a protective film is improved, and a more rigid and more stable protective coat is formed. Accordingly, decomposition reaction of the electrolytic solution is more inhibited.

Examples of the halogenated chain ester carbonate include fluoromethyl methyl carbonate, bis (fluoromethyl) carbonate, and difluoromethyl methyl carbonate. Examples of the halogenated cyclic ester carbonate include 4-fluoro-1,3-dioxolane-2-one and 4,5-difluoro-1,3-dioxolane-2-one. Halogenated cyclic ester carbonate includes a geometric isomer as well. Contents of the halogenated chain ester carbonate and the halogenated cyclic ester carbonate in the solvent is, for example, from 0.01 wt % to 50 wt % both inclusive.

Further, the solvent preferably contains an unsaturated carbon bond cyclic ester carbonate. Thereby, a stable coat is formed on the surface of the anode 22 at the time of charge and discharge, and thus decomposition of the electrolytic solution is inhibited. The unsaturated carbon bond cyclic ester carbonate is a cyclic ester carbonate having an unsaturated carbon bond (unsaturated carbon bond is introduced to a given location). Examples of the unsaturated carbon bond cyclic ester carbonate include vinylene carbonate and vinylethylene carbonate. Contents of the unsaturated carbon bond cyclic ester carbonate in the solvent is, for example, from 0.01 wt % to 10 wt % both inclusive.

Further, the solvent preferably contains sultone (cyclic sulfonic ester), since thereby chemical stability of the electrolytic solution is improved. Examples of the sultone include propane sultone and propene sultone. The sultone content in the solvent is, for example, from 0.5 wt % to 5 wt % both inclusive.

Further, the solvent preferably contains an acid anhydride since chemical stability of the electrolytic solution is thereby improved. Examples of acid anhydrides include carboxylic anhydride, disulfonic anhydride, and a carboxylic sulfonic anhydride. Examples of carboxylic anhydrides include succinic anhydride, glutaric anhydride, and maleic anhydride. Examples of disulfonic anhydrides include ethane disulfonic anhydride and propane disulfonic anhydride. Examples of carboxylic sulfonic anhydrides include sulfobenzoic anhydride, sulfopropionic anhydride, and sulfobutyric anhydride. The content of the acid anhydride in the solvent is, for example, from 0.5 wt % to 5 wt % both inclusive.

The electrolyte salt contains, for example, one or more light metal salts such as a lithium salt. Examples of lithium salts include the following. That is, examples thereof include lithium hexafluorophosphate (LiPF₆), lithium tetrafluoroborate (LiBF₄), lithium perchlorate (LiClO₄), and lithium hexafluoroarsenate (LiAsF₆). Further, examples thereof include lithium tetraphenylborate (LiB(C₆H₅)₄), lithium methanesulfonate (LiCH₃SO₃), lithium trifluoromethane sulfonate (LiCF₃SO₃), and lithium tetrachloroaluminate (LiAlCl₄). Further, examples thereof include dilithium hexafluorosilicate (Li₂SiF₆), lithium chloride (LiCl), and lithium bromide (LiBr). In the case of using the foregoing material, superior battery capacity, superior cycle characteristics, and superior storage characteristics and the like are obtained.

Specially, one or more of lithium hexafluorophosphate, lithium tetrafluoroborate, lithium perchlorate, and lithium hexafluoroarsenate is preferable. Further, lithium hexafluorophosphate and lithium tetrafluoroborate are more preferable, and lithium hexafluorophosphate is most preferable, since the internal resistance is lowered, more superior effect is obtained.

The content of the electrolyte salt to the solvent is preferably from 0.3 mol/kg to 3.0 mol/kg both inclusive, since thereby high ion conductivity is obtained.

Operation of the Square Type Secondary Battery

In the square type secondary battery, at the time of charge, for example, lithium ions extracted from the cathode 21 are inserted in the anode 22 through the electrolytic solution. Meanwhile, at the time of discharge, for example, lithium ions extracted from the anode 22 are inserted in the cathode 21 through the electrolytic solution.

Method of Manufacturing the Square Type Secondary Battery

The secondary battery is manufactured, for example, by the following procedure.

First, the cathode 21 is formed. First, a cathode active material and, if necessary, a cathode binder, a cathode electrical conductor or the like are mixed to prepare a cathode mixture, which is subsequently dispersed in an organic solvent or the like to form a paste cathode mixture slurry. Subsequently, the cathode current collector 21A is coated with the cathode mixture slurry by using a coating equipment such as a doctor blade and a bar coater, which is dried to form the cathode active material layer 21. Finally, the cathode active material layer 21 is compression-molded by a rolling press machine or the like while being heated if necessary. In this case, the resultant may be compression-molded over several times.

Next, the anode 22 is formed by forming the anode active material layer 22B on the anode current collector 22A according to a forming procedure similar to that of the foregoing anode for a lithium ion secondary battery.

Next, the battery element 20 is formed. First, the cathode lead 24 is attached to the cathode current collector 21A and the anode lead 25 is attached to the anode current collector 22A by welding method. Subsequently, the cathode 21 and the anode 22 are layered with a separator 23 in between, and the laminated body is spirally wound in the longitudinal direction. Finally, the wound body is formed into a planular shape.

Finally, the square type secondary battery is assembled. First, after the battery element 20 is contained in the battery can 11, the insulating plate 12 is arranged on the battery element 20. Subsequently, the cathode lead 24 is attached to the cathode pin 15, and the anode lead 25 is attached to the battery can 11 by welding method or the like. In this case, the battery cover 13 is fixed on the open end of the battery can 11 by laser welding method or the like. Finally, the electrolytic solution is injected into the battery can 11 from the injection hole 19, and impregnated in the separator 23. After that, the injection hole 19 is sealed by the sealing member 19A.

Action and Effect of the Square Type Secondary Battery

According to the square type secondary battery, the anode 22 has a structure similar to that of the foregoing anode for a lithium ion secondary battery. Thus, at the time of charge and discharge, decomposition reaction of the electrolytic solution and gas generation caused by the decomposition reaction of the electrolytic solution are inhibited. Therefore, the cycle characteristics and the swollenness characteristics are able to be improved. Other effect is similar to that of the anode for a lithium ion secondary battery.

2-2. Cylindrical Type

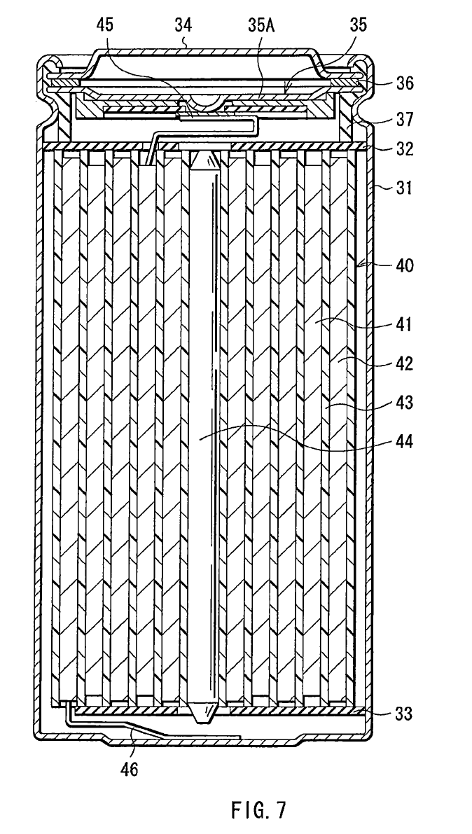

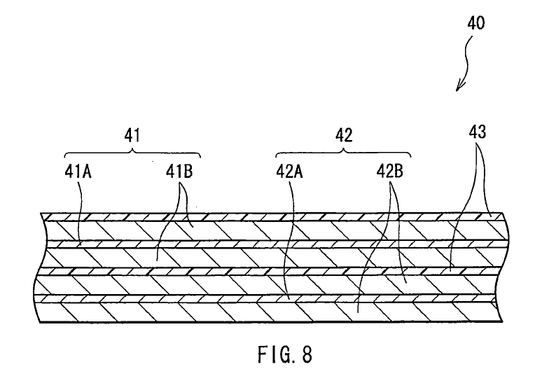

FIG. 7 and FIG. 8 illustrate a cross sectional structure of a cylindrical type secondary battery. FIG. 8 illustrates an enlarged part of a wound electrode body 40 illustrated in FIG. 7. In the following description, the elements of the square type secondary battery described above will be cited as needed.

Structure of the Cylindrical Type Secondary Battery

The cylindrical type secondary battery mainly contains a wound electrode body 40 and a pair of insulating plates 32 and 33 inside a battery can 31 in the shape of an approximately hollow cylinder. The wound electrode body 40 is a wound laminated body in which a cathode 41 and an anode 42 are layered with a separator 43 in between and are spirally wound.

The battery can 31 has a hollow structure in which one end of the battery can 31 is closed, and the other end of the battery can 31 is opened. For example, the battery can 31 is made of, for example, a material similar to that of the battery can 11. The pair of insulating plates 32 and 33 is arranged to sandwich the wound electrode body 40 in between and to extend perpendicularly to the wound periphery face.

At the open end of the battery can 31, a battery cover 34, a safety valve mechanism 35, and a PTC (Positive Temperature Coefficient) device 36 are attached by being caulked with a gasket 37. Inside of the battery can 31 is hermetically sealed. The battery cover 34 is made of, for example, a material similar to that of the battery can 31. The safety valve mechanism 35 and the PTC device 36 are provided inside of the battery cover 34. The safety valve mechanism 35 is electrically connected to the battery cover 34 through the PTC device 36. In the safety valve mechanism 35, in the case where the internal pressure becomes a certain level or more by internal short circuit, external heating or the like, a disk plate 35A inverts to cut the electric connection between the battery cover 34 and the wound electrode body 40. As temperature rises, the PTC device 36 increases the resistance and thereby limits a current to prevent abnormal heat generation resulting from a large current. The gasket 37 is made of, for example, an insulating material. The surface of the gasket 37 is coated with, for example, asphalt.

In the center of the wound electrode body 40, a center pin 44 may be inserted. A cathode lead 45 made of a conductive material such as aluminum is connected to the cathode 41, and an anode lead 46 made of a conductive material such as nickel is connected to the anode 42. The cathode lead 45 is electrically connected to the battery cover 34 by, for example, being welded to the safety valve mechanism 35. The anode lead 46 is, for example, welded and thereby electrically connected to the battery can 31.

The cathode 41 has a cathode active material layer 41B on both faces of a cathode current collector 41A. The anode 42 has a structure similar to that of the anode for a lithium ion secondary battery described above, and has, for example, an anode active material layer 42B on both faces of an anode current collector 42A. The structures of the cathode current collector 41A, the cathode active material layer 41B, the anode current collector 42A, the anode active material layer 42B, and the separator 43 are similar to the structures of the cathode current collector 21A, the cathode active material layer 21B, the anode current collector 22A, the anode active material layer 22B, and the separator 23. The composition of the electrolytic solution impregnated in the separator 35 is similar to the composition of the electrolytic solution in the square type secondary battery.

Operation of the Cylindrical Type Secondary Battery

In the cylindrical type secondary battery, at the time of charge, for example, lithium ions extracted from the cathode 41 are inserted in the anode 42 through the electrolytic solution. Meanwhile, at the time of discharge, for example, lithium ions extracted from the anode 42 are inserted in the cathode 41 through the electrolytic solution.

Method of Manufacturing the Cylindrical Type Secondary Battery

The cylindrical type secondary battery is manufactured, for example, by the following procedure. First, for example, the cathode 41 is formed by forming the cathode active material layer 41B on both faces of the cathode current collector 41A and the anode 42 is formed by forming the anode active material layer 42B on both faces of the anode current collector 42A with the use of procedures similar to the procedures of forming the cathode 21 and the anode 22. Subsequently, the cathode lead 45 is attached to the cathode 41, and the anode lead 46 is attached to the anode 42 by welding method or the like. Subsequently, the cathode 41 and the anode 42 are layered with the separator 43 in between and spirally wound, and thereby the wound electrode body 40 is formed. After that, the center pin 44 is inserted in the center of the wound electrode body. Subsequently, the wound electrode body 40 is sandwiched between the pair of insulating plates 32 and 33, and contained in the battery can 31. In this case, the cathode lead 45 is attached to the safety valve mechanism 35, and the end of the anode lead 46 is attached to the battery can 31 by welding method or the like. Subsequently, the electrolytic solution is injected into the battery can 31 and impregnated in the separator 43. Finally, after the battery cover 34, the safety valve mechanism 35, and the PTC device 36 are attached to the open end of the battery can 31, the resultant is caulked with the gasket 37

Action and Effect of the Cylindrical Type Secondary Battery

According to the cylindrical type secondary battery, the anode 42 has a structure similar to that of the foregoing anode for a lithium ion secondary battery. Therefore, the cycle characteristics and the swollenness characteristics are able to be improved for the reason similar to that of the square type secondary battery. Other effects of the cylindrical type secondary battery are similar to those of the anode for a lithium ion secondary battery.

2-3. Laminated Film Type

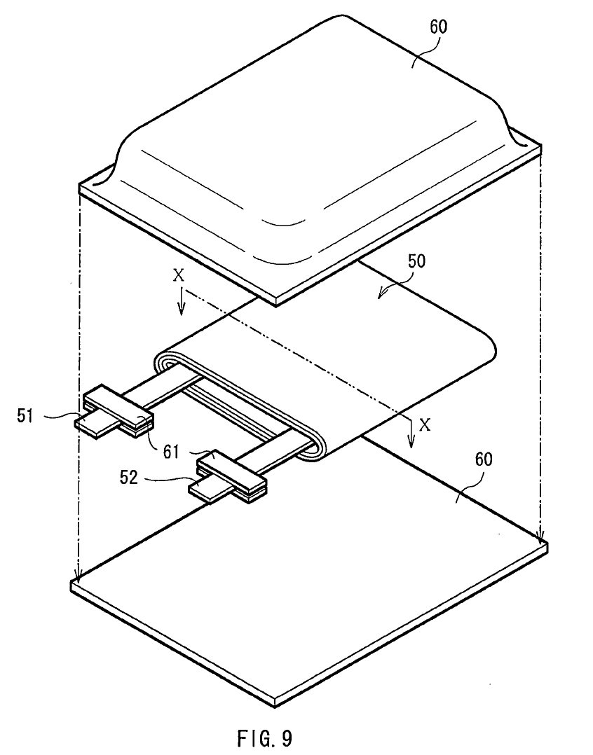

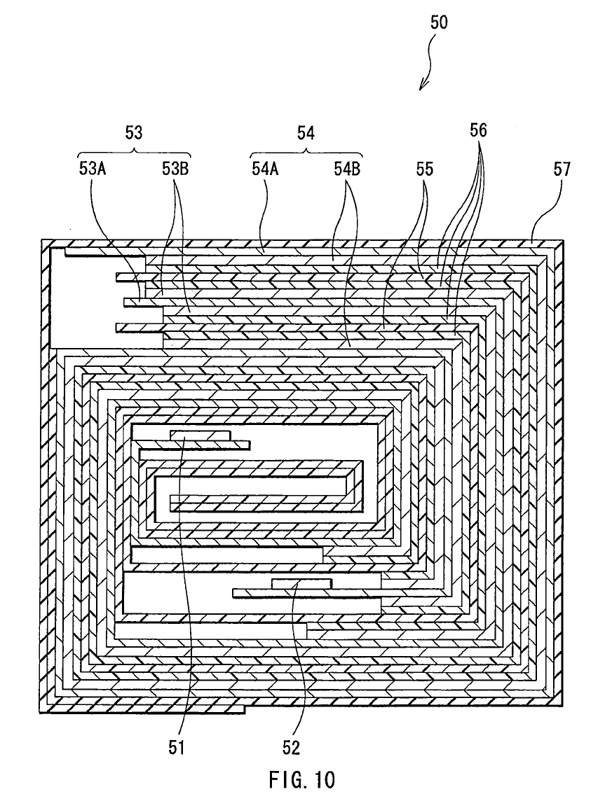

FIG. 9 illustrates an exploded perspective structure of a laminated film type secondary battery. FIG. 10 illustrates an exploded cross section taken along line X-X of a wound electrode body 50 illustrated in FIG. 9.

Structure of the Laminated Film Type Secondary Battery

In the laminated film type secondary battery, a wound electrode body 50 is contained in a film package member 60 mainly. The wound electrode body 50 is a wound electrode body in which a cathode 53 and an anode 54 are layered with a separator 55 and an electrolyte layer 56 in between and are spirally wound. A cathode lead 51 is attached to the cathode 53, and an anode lead 52 is attached to the anode 54. The outermost peripheral section of the wound electrode body 50 is protected by a protective tape 57.

The cathode lead 51 and the anode lead 52 are, for example, respectively derived from inside to outside of the package member 60 in the same direction. The cathode lead 51 is made of, for example, a conductive material such as aluminum, and the anode lead 52 is made of, for example, a conducive material such as copper, nickel, and stainless steel. These materials are in the shape of, for example, a thin plate or mesh.

The package member 60 is a laminated film in which, for example, a fusion bonding layer, a metal layer, and a surface protective layer are layered in this order. In the laminated film, for example, the respective outer edges of the fusion bonding layer of two films are bonded with each other by fusion bonding, an adhesive or the like so that the fusion bonding layer and the wound electrode body 50 are opposed to each other. Examples of fusion bonding layers include a film made of polyethylene, polypropylene or the like. Examples of metal layers include an aluminum foil. Examples of surface protective layers include a film made of nylon, polyethylene terephthalate or the like.

Specially, as the package member 60, an aluminum laminated film in which a polyethylene film, an aluminum foil, and a nylon film are layered in this order is preferable. However, the package member 60 may be made of a laminated film having other laminated structure, a polymer film such as polypropylene, or a metal film.

An adhesive film 61 to protect from outside air intrusion is inserted between the package member 60 and the cathode lead 51, the anode lead 52. The adhesive film 61 is made of a material having contact characteristics with respect to the cathode lead 51 and the anode lead 52. Examples of such a material include, for example, a polyolefin resin such as polyethylene, polypropylene, modified polyethylene, and modified polypropylene.

The cathode 53 has a cathode active material layer 53B on both faces of a cathode current collector 53A. The anode 54 has a structure similar to that of the foregoing anode for a lithium ion secondary battery, and has, for example, an anode active material layer 54B on both faces of an anode current collector 54A. The structures of the cathode current collector 53A, the cathode active material layer 53B, the anode current collector 54A, and the anode active material layer 54B are respectively similar to the structures of the cathode current collector 21A, the cathode active material layer 21B, the anode current collector 22A and the anode active material layer 22B. The structure of the separator 55 is similar to the structure of the separator 23.

In the electrolyte layer 56, an electrolytic solution is held by a polymer compound. The electrolyte layer 56 may contain other material such as an additive according to needs. The electrolyte layer 56 is a so-called gel electrolyte. The gel electrolyte is preferable, since high ion conductivity (for example, 1 mS/cm or more at room temperature) is obtained and liquid leakage of the electrolytic solution is prevented.

Examples of polymer compounds include one or more of the following polymer materials. That is, examples thereof include polyacrylonitrile, polyvinylidene fluoride, polytetrafluoroethylene, polyhexafluoropropylene, polyethylene oxide, polypropylene oxide, polyphosphazene, polysiloxane, and polyvinyl fluoride. Further, examples thereof include polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. Further, examples thereof include a copolymer of vinylidene fluoride and hexafluoro propylene. Specially, polyvinylidene fluoride or the copolymer of vinylidene fluoride and hexafluoro propylene is preferable, since such a polymer compound is electrochemically stable.

The composition of the electrolytic solution is similar to the composition of the electrolytic solution in the square type secondary battery. However, in the electrolyte layer 56 as the gel electrolyte, a solvent of the electrolytic solution means a wide concept including not only the liquid solvent but also a material having ion conductivity capable of dissociating the electrolyte salt. Therefore, in the case where the polymer compound having ion conductivity is used, the polymer compound is also included in the solvent.

Instead of the gel electrolyte layer 56, the electrolytic solution may be directly used. In this case, the electrolytic solution is impregnated in the separator 55.

Operation of the Laminated Film Type Secondary Battery

In the laminated film type secondary battery, at the time of charge, for example, lithium ions extracted from the cathode 53 are inserted in the anode 54 through the electrolyte layer 56. Meanwhile, at the time of discharge, for example, lithium ions extracted from the anode 54 are inserted in the cathode 53 through the electrolyte layer 56.

Method of Manufacturing the Laminated Film Type Secondary Battery

The laminated film type secondary battery including the gel electrolyte layer 56 is manufactured, for example, by the following three procedures.

In the first procedure, first, the cathode 53 and the anode 54 are formed by a formation procedure similar to that of the cathode 21 and the anode 22. In this case, the cathode 53 is formed by forming the cathode active material layer 53B on both faces of the cathode current collector 53A, and the anode 54 is formed by forming the anode active material layer 54B on both faces of the anode current collector 54A. Subsequently, a precursor solution containing an electrolytic solution, a polymer compound, and a solvent such as an organic solvent is prepared. After that, the cathode 53 and the anode 54 are coated with the precursor solution to form the gel electrolyte layer 56. Subsequently, the cathode lead 51 is attached to the cathode current collector 53A and the anode lead 52 is attached to the anode current collector 54A by welding method or the like. Subsequently, the cathode 53 and the anode 54 provided with the electrolyte layer 56 are layered with the separator 55 in between and spirally wound to form the wound electrode body 50. After that, the protective tape 57 is adhered to the outermost periphery thereof. Finally, after the wound electrode body 50 is sandwiched between two pieces of film-like package members 60, outer edges of the package members 60 are contacted to each other by thermal fusion bonding method or the like to enclose the wound electrode body 50 into the package members 60. In this case, the adhesive films 61 are inserted between the cathode lead 51, the anode lead 52 and the package member 60.

In the second procedure, first, the cathode lead 51 is attached to the cathode 53, and the anode lead 52 is attached to the anode 54. Subsequently, the cathode 53 and the anode 54 are layered with the separator 55 in between and spirally wound to form a spirally wound body as a precursor of the wound electrode body 50. After that, the protective tape 57 is adhered to the outermost periphery thereof. Subsequently, after the spirally wound body is sandwiched between two pieces of the film-like package members 60, the outermost peripheries except for one side are bonded by thermal fusion bonding method or the like to obtain a pouched state, and the wound body is contained in the pouch-like package member 60. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 60. After that, the opening of the package member 60 is hermetically sealed by using thermal fusion bonding method or the like. Finally, the monomer is thermally polymerized to obtain a polymer compound. Thereby, the gel electrolyte layer 56 is formed.

In the third procedure, firstly, the wound body is formed and contained in the pouch-like package member 60 in the same manner as that of the foregoing second procedure, except that the separator 55 with both faces coated with a polymer compound is used. Examples of polymer compounds with which the separator 55 is coated include a polymer containing vinylidene fluoride as a component (a homopolymer, a copolymer, a multicomponent copolymer or the like). Specific examples thereof include polyvinylidene fluoride, a binary copolymer containing vinylidene fluoride and hexafluoro propylene as a component, and a ternary copolymer containing vinylidene fluoride, hexafluoro propylene, and chlorotrifluoroethylene as a component. In addition to the polymer containing vinylidene fluoride as a component, another one or more polymer compounds may be used. Subsequently, an electrolytic solution is prepared and injected into the package member 60. After that, the opening of the package member 60 is sealed by thermal fusion bonding method or the like. Finally, the resultant is heated while a weight is applied to the package member 60, and the separator 55 is contacted with the cathode 53 and the anode 54 with the polymer compound in between. Thereby, the electrolytic solution is impregnated into the polymer compound, and the polymer compound is gelated to form the electrolyte layer 56.

In the third procedure, the swollenness of the battery is inhibited compared to the first procedure. Further, in the third procedure, the monomer, the solvent and the like as a raw material of the polymer compound are hardly left in the electrolyte layer 56 compared to the second procedure. Thus, the formation step of the polymer compound is favorably controlled. Therefore, sufficient contact characteristics are obtained between the cathode 53/the anode 54/the separator 55 and the electrolyte layer 56.

Action and Effect of the Laminated Film Type Secondary Battery

According to the laminated film type secondary battery, the anode 54 has a structure similar to that of the foregoing anode for a lithium ion secondary battery. Therefore, the cycle characteristics and the swollenness characteristics are able to be improved for the reason similar to that of the square type secondary battery. Other effects of the laminated film type secondary battery are similar to those of the anode for a lithium ion secondary battery.

### EXAMPLES

Examples of the invention will be described in detail.

### Examples 1-1 to 1-9

The laminated film type secondary battery illustrated in FIG. 9 and FIG. 10 was fabricated by the following procedure.

First, the cathode 53 was formed. First, 91 parts by mass of the cathode active material (lithium-cobalt composite oxide (LiCoO₂)), 6 parts by mass of a cathode electrical conductor (graphite), and 3 parts by mass of a cathode binder (polyvinylidene fluoride: PVDF) were mixed to obtain a cathode mixture. Subsequently, the cathode mixture was dispersed in an organic solvent (N-methyl-2-pyrrolidone: NMP) to obtain a paste cathode mixture slurry. Subsequently, both faces of the cathode current collector 53A were coated with the cathode mixture slurry by a coating equipment, which was dried to form the cathode active material layer 53B. In this case, as the cathode current collector 53A, a strip-shaped aluminum foil (thickness: 12 μm) was used. Finally, the cathode active material layer 53B was compression-molded by a roll pressing machine. In the case where the cathode active material layer 53B is formed, the thickness was adjusted to prevent lithium metal from being precipitated on the anode 54 at the time of full charge.

Next, the anode 54 was formed. First, as an anode material, the silicon alloy powder (median diameter: 1 μm) illustrated in Table 1 was formed by gas atomization method. In this case, pulverized material (powder) of 99.99% high purity monocrystal silicon and 99.9% purity metal powder were used. Subsequently, the metal material (plating film) illustrated in Table 1 was grown so that the surface of the anode material was coated by nonelectrolytic plating method. In this case, after the anode material was dipped in palladium chloride solution for several minutes, nonelectrolytic plating reaction was progressed at 60 degrees Celsius or more. Finally, the anode material coated with the metal material was deposited on both faces of the anode current collector 54A by PJD method, and thereby the anode active material layer 54B containing the anode active material and the metal conductive material was formed. In this case, as the anode current collector 54A, a roughened strip-shaped electrolytic copper foil (thickness: 15 μm) was used. Further, in the case where the anode active material layer 54B was formed, an anode material not coated with the metal material was added to the anode material coated with the metal material, the median diameter thereof and the addition amount thereof were changed, and thereby the void ratio was adjusted to become the value illustrated in Table 1.

Next, solvents (ethylene carbonate (EC) and diethyl carbonate (DEC)) were mixed. After that, an electrolyte salt (lithium hexafluorophosphate (LiPF₆) was dissolved in the solvent to prepare an electrolytic solution. In this case, the solvent composition (EC:DEC) was 50:50 at a weight ratio. The content of the electrolyte salt to the solvent was 1 mol/kg.

Finally, the secondary battery was assembled. First, the cathode lead 51 made of aluminum was welded to one end of the cathode current collector 53A, and the anode lead 52 made of nickel was welded to one end of the anode current collector 54A. Subsequently, the cathode 53, the separator 55, the anode 54, and the separator 55 were layered in this order and spirally wound in the longitudinal direction to form a spirally wound body as a precursor of the wound electrode body 50. After that, the end section of the wound body was fixed by the protective tape 57 (adhesive tape). In this case, as the separator 55, a laminated film (thickness: 20 μm) in which a film made of a microporous polyethylene as a main component was sandwiched between films made of a microporous polypropylene as a main component was used. Subsequently, the wound body was sandwiched between the package members 60. After that, outer edges other than an edge of one side of the package members were thermally fusion-bonded with each other. Thereby, the wound body was contained in the package members 60 in a pouched state. In this case, as the package member 60, an aluminum laminated film in which a nylon film (thickness: 30 μm), an aluminum foil (thickness: 40 μm), and a non-stretch polypropylene film (thickness 30 μm) were layered from the outside was used. Subsequently, the electrolytic solution was injected through the opening of the package member 60, the electrolytic solution was impregnated in the separator 55, and thereby the wound electrode body 50 was formed. Finally, the opening of the package member 60 was sealed by thermal fusion bonding in the vacuum atmosphere, and therefore the package members 60 were sealed.

The cycle characteristics and the swollenness characteristics for the secondary batteries were examined. The results illustrated in Table 1 were obtained.

In examining the cycle characteristics, first, to stabilize the battery state, after 1 cycle of charge and discharge was performed in the atmosphere at 23 degrees Celsius, charge and discharge were performed again to measure the discharge capacity. Subsequently, the secondary battery was charged and discharged until the total number of cycles became 100 cycles to measure the discharge capacity. Finally, capacity retention ratio (%)=(discharge capacity at the 100th cycle/discharge capacity at the second cycle)*100 was calculated. At the time of charge, after charge was performed at the constant current density of 3 mA/cm² until the battery voltage reached 4.2 V, charge was performed at the constant voltage of 4.2 V until the battery density reached 0.3 mA/cm². Further, at the time of discharge, discharge was performed at the constant current density of 3 mA/cm² until the battery voltage reached 2.5 V.

In examining the swollenness characteristics, the thickness at the second cycle and the 100th cycle was measured in the case of examining the cycle characteristics. After that, the swollenness ratio (%)=(thickness at the 100th cycle/thickness at the second cycle)*100 was calculated.

TABLE 1

| | Anode active material layer | | | | | Capacity | |
|---|---|---|---|---|---|---|---|
| | | | Metal | | | retention | Swollenness |
| | Anode active | | conductive | Forming | Void ratio | ratio | ratio |
| | material (wt %) | | material | method | (%) | (%) | (%) |
| Example 1-1 | Si | Fe(0.2) | Cu | PJD | 1 | 83.6 | 1.5 |
| Example 1-2 | | | | method | 3 | 83.1 | 1.5 |
| Example 1-3 | | | | | 5 | 82.5 | 1.5 |
| Example 1-4 | | | | | 7 | 82 | 1.5 |
| Example 1-5 | | | | | 10 | 80.3 | 2 |
| Example 1-6 | | | | | 13 | 70 | 7 |
| Example 1-7 | | | | | 20 | 67 | 10 |
| Example 1-8 | | | | | 25 | 63 | 17 |
| Example 1-9 | | | | | 30 | 56 | 20 |

As the void ratio of the anode active material layer 2 was decreased, the capacity retention ratio was gradually increased and the swollenness ratio was gradually decreased. In this case, in the case where the void ratio was 10% or less, the capacity retention ratio was significantly high and the swollenness ratio was significantly kept small. Further, in the case where the void ratio was 7% or less, the capacity retention ratio was higher and the swollenness ratio was smaller.

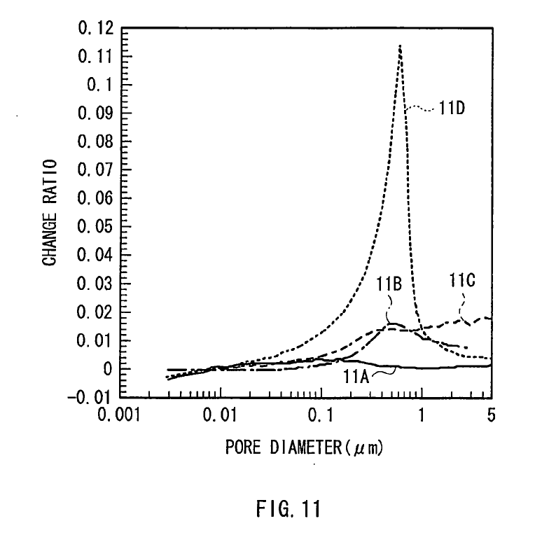

The pore diameter distribution of the void existing in the anode active material layer 2 was examined by a mercury porosimeter. The results illustrated in FIG. 11 were obtained. Curved lines 11A to 11D respectively indicate measurement results of Examples 1-2 to 1-4 and 1-6. In this case, after the anode 54 was cut in 25 mm*350 mm size, distribution of change ratio of mercury penetration amount was measured by the mercury porosimeter made by Micromeritics Co. (Autopore 9500 series).

As evidenced by the results of FIG. 11, in the case where the void ratio was 10% or less, the pore diameter of the void did not concentrate on a specific value but was dispersed, and the pore diameter distribution did not show a peak but almost remained at the same level. Thereby, the surface area of the anode active material layer 2 was significantly decreased.

### Examples 2-1 to 2-15

A secondary battery was fabricated by a procedure similar to that of Example 1-3, except that the surface roughness (ten point height of roughness profile Rz) of the anode current collector 54A was changed, or AD method was used instead of PJD method, and the cycle characteristics and the swollenness characteristics were examined. To change the ten point height of roughness profile Rz, an electrolytic copper foil with different roughness degree was used as the anode current collector 54A.

TABLE 2

| | | | | | | Anode | | |
|---|---|---|---|---|---|---|---|---|
| | | | | | | current | | |
| | | | | | | collector | | |
| | Anode active material layer | | | | | Ten point | | |
| | Anode | | | | | height of | Capacity | |
| | active | | Metal | | Void | roughness | retention | Swollenness |
| | material | | conductive | Forming | ratio | profile Rz | ratio | ratio |
| | (wt %) | | material | method | (%) | (μm) | (%) | (%) |
| Example 2-1 | Si | Fe(0.2) | Cu | PJD | 5 | 0.01 | 83.2 | 1.1 |
| Example 2-2 | | | | method | | 0.05 | 83.2 | 1.1 |
| Example 2-3 | | | | | | 0.1 | 83.2 | 1.1 |
| Example 2-4 | | | | | | 0.2 | 83.2 | 1.2 |
| Example 2-5 | | | | | | 0.3 | 83.1 | 1.2 |
| Example 2-6 | | | | | | 0.5 | 82.9 | 1.2 |
| Example 2-7 | | | | | | 0.8 | 82.8 | 1.3 |
| Example 1-3 | | | | | | 1 | 82.7 | 1.3 |
| Example 2-8 | | | | | | 1.5 | 81.5 | 1.4 |
| Example 2-9 | | | | | | 2 | 81.4 | 1.4 |
| Example 2-10 | | | | | | 3 | 80.7 | 1.9 |
| Example 2-11 | | | | | | 4 | 80.2 | 2 |
| Example 2-12 | Si | Fe(0.2) | Cu | AD | 5 | 0.5 | 82.9 | 1.2 |
| Example 2-13 | | | | method | | 1 | 81.6 | 1.3 |
| Example 2-14 | | | | | | 2 | 80.6 | 1.4 |
| Example 2-15 | | | | | | 3 | 80 | 1.8 |

In the case where PJD method was used, a high capacity retention ratio and a small swollenness ratio were obtained not depending on the ten point height of roughness profile Rz. In particular, in the case where the ten point height of roughness profile Rz is 2 μm or less, and more particularly 1 μm or less, the capacity retention ratio was higher and the swollenness ratio was smaller.

In the case where AD method was used, a high capacity retention ratio and a small swollenness ratio were obtained as in the case of using PJD method.

In the case where PJD method and AD method were used, as the ten point height of roughness profile Rz was decreased, the capacity retention ratio was gradually increased and the swollenness ratio was gradually decreased. Such a tendency is a specific tendency obtained in the case of using impact binding phenomenon, and is different from general tendency that film forming method and surface roughness (in this case, ten point height of roughness profile Rz) affect the cycle characteristics and the swollenness characteristics.

More specifically, general vapor-phase deposition method such as evaporation method, sputtering method, and spraying method is used, the anode material is deposited (contacted) by anchor effect using surface roughness of the anode current collector 54A. In this case, as the surface roughness is decreased, contact characteristics of the anode material are decreased. Thus, the anode active material layer 54B is easily dropped from the anode current collector 54A. Such dropping of the anode active material layer 54B causes lowering of the discharge capacity and decomposition of the electrolytic solution. Thus, the cycle characteristics and the swollenness characteristics are easily lowered.

Meanwhile, in the PJD method using the impact binding phenomenon, the anode material is ejected (accelerated) from the nozzle by high speed gas flow such as air (gas such as helium, nitrogen, argon, and oxygen may be used). Thereby, the anode material impacts the anode current collector 54A, and thus the anode material is deposited on the surface of the anode current collector 54A by using impact energy (motion energy). In this case, the contact characteristics of the anode material are sufficiently increased without being affected by the surface roughness of the anode current collector 54A. Thus, even if the surface roughness is small, the anode active material layer 54B is hardly dropped from the anode current collector 54A. Instead, in PJD method, as the surface roughness of the anode current collector 54A is increased, the anode material is easily scattered in the course of deposition. Thus, the anode material is hardly deposited (contacted) on the surface of the anode current collector 54A. Such deposition principle is similarly obtained for the metal material. Further, such deposition principle is similarly obtained in AD method in which the anode material and the metal material are deposited by using impact energy due to aerosol (ejection rate: several hundred m/sec). Thus, even if the surface roughness is small, the cycle characteristics and the swollenness characteristics are secured. Instead, reverse phenomenon that both characteristics are improved as the surface roughness is decreased occurs.

### Examples 3-1 to 3-42

A secondary battery was fabricated by a procedure similar to that of Examples 1-3, 2-6, and 2-10 except that the metal conductive material type was changed as illustrated in Table 3 and Table 4, and the cycle characteristics and the swollenness characteristics were examined. To change the metal conductive material type, type of the metal material with which the surface of the anode material was coated was changed.

TABLE 3

| | | | | | | Anode | | |
|---|---|---|---|---|---|---|---|---|
| | | | | | | current | | |
| | | | | | | collector | | |
| | Anode active material layer | | | | | Ten point | | |
| | Anode | | | | | height of | Capacity | |
| | active | | Metal | | Void | roughness | retention | Swollenness |
| | material | | conductive | Forming | ratio | profile Rz | ratio | ratio |
| | (wt %) | | material | method | (%) | (μm) | (%) | (%) |
| Example 3-1 | Si | Fe(0.2) | Ni | PJD | 5 | 0.5 | 82.1 | 1.3 |
| Example 3-2 | | | | method | | 1 | 81.6 | 1.4 |
| Example 3-3 | | | | | | 2 | 81.3 | 1.5 |
| Example 3-4 | | | Co | PJD | 5 | 0.5 | 81.5 | 1.2 |
| Example 3-5 | | | | method | | 1 | 80.9 | 1.4 |
| Example 3-6 | | | | | | 2 | 80.5 | 1.4 |
| Example 3-7 | | | Fe | PJD | 5 | 0.5 | 82.8 | 1.3 |
| Example 3-8 | | | | method | | 1 | 82.1 | 1.4 |
| Example 3-9 | | | | | | 2 | 81.9 | 1.5 |
| Example 3-10 | | | Zn | PJD | 5 | 0.5 | 81.5 | 1.3 |
| Example 3-11 | | | | method | | 1 | 80.9 | 1.4 |
| Example 3-12 | | | | | | 2 | 80.5 | 1.4 |
| Example 3-13 | | | Al | PJD | 5 | 0.5 | 80.9 | 1.4 |
| Example 3-14 | | | | method | | 1 | 80.6 | 1.5 |
| Example 3-15 | | | | | | 2 | 80.4 | 1.6 |
| Example 3-16 | | | Cr | PJD | 5 | 0.5 | 82.4 | 1.5 |
| Example 3-17 | | | | method | | 1 | 81.5 | 1.6 |
| Example 3-18 | | | | | | 2 | 81.0 | 1.7 |
| Example 3-19 | | | Mn | PJD | 5 | 0.5 | 81.9 | 1.3 |
| Example 3-20 | | | | method | | 1 | 81.2 | 1.4 |
| Example 3-21 | | | | | | 2 | 80.9 | 1.5 |

TABLE 4

| | | | | | | Anode | | |
|---|---|---|---|---|---|---|---|---|
| | | | | | | current | | |
| | | | | | | collector | | |
| | Anode active material layer | | | | | Ten point | | |
| | Anode | | | | | height of | Capacity | |
| | active | | Metal | | Void | roughness | retention | Swollenness |
| | material | | conductive | Forming | ratio | profile Rz | ratio | ratio |
| | (wt %) | | material | method | (%) | (μm) | (%) | (%) |
| Example 3-22 | Si | Fe(0.2) | Ti | PJD | 5 | 0.5 | 83.2 | 1.4 |
| Example 3-23 | | | | method | | 1 | 82.6 | 1.5 |
| Example 3-24 | | | | | | 2 | 82.1 | 1.6 |
| Example 3-25 | | | Zr | PJD | 5 | 0.5 | 82.9 | 1.5 |
| Example 3-26 | | | | method | | 1 | 82 | 1.6 |
| Example 3-27 | | | | | | 2 | 81.7 | 1.8 |
| Example 3-28 | | | Mo | PJD | 5 | 0.5 | 83 | 1.3 |
| Example 3-29 | | | | method | | 1 | 82.5 | 1.4 |
| Example 3-30 | | | | | | 2 | 82.1 | 1.5 |
| Example 3-31 | | | W | PJD | 5 | 0.5 | 83.1 | 1.4 |
| Example 3-32 | | | | method | | 1 | 82.9 | 1.5 |
| Example 3-33 | | | | | | 2 | 82.7 | 1.7 |
| Example 3-34 | | | Ag | PJD | 5 | 0.5 | 80.3 | 1.6 |
| Example 3-35 | | | | method | | 1 | 80.1 | 1.7 |
| Example 3-36 | | | | | | 2 | 80 | 1.8 |
| Example 3-37 | | | In | PJD | 5 | 0.5 | 80.4 | 1.5 |
| Example 3-38 | | | | method | | 1 | 81 | 1.6 |
| Example 3-39 | | | | | | 2 | 80 | 1.7 |
| Example 3-40 | | | Sn | PJD | 5 | 0.5 | 80.9 | 1.9 |
| Example 3-41 | | | | method | | 1 | 80.6 | 2 |
| Example 3-42 | | | | | | 2 | 80.4 | 2.1 |

Even if the ten point height of roughness profile Rz was small, a high capacity retention ratio and a small swollenness ratio were obtained without depending on the metal conductive material type.

### Examples 4-1 to 4-15

A secondary battery was fabricated by a procedure similar to that of Examples 1-3, 2-6, and 2-10 except that the forming method of the anode active material layer 54B was changed as illustrated in Table 5, and the cycle characteristics and the swollenness characteristics were examined.

In the case where spraying method (gas flame spraying method) was used, mixed gas of hydrogen (H₂) and oxygen (O₂) (hydrogen:oxygen=2:1 at a volume ratio) as spraying gas and nitrogen gas (N₂) as material supply gas were respectively used. In this case, the anode material was sprayed while the anode current collector 54A was cooled with carbon dioxide gas, and the spraying rate was from about 45 msec to 55 msec both inclusive. In the case where sputtering method (RF magnetron sputtering method) was used, the deposition rate was 0.5 nm/sec.

In the case where evaporation method or the like or plating method was used, after the anode active material was formed by depositing the anode material by evaporation method or the like, a plating film was grown by electrolytic plating method to form the metal conductive material. In the case where evaporation method (electron beam evaporation method) was used, a deflecting electron beam evaporation source (99% purity silicon) was used, the deposition rate was 100 nm/sec, and the pressure was in the vacuum state of 1*10⁻³ Pa by a turbo-molecular pump. In the case where electrolytic plating method was used, a copper plating bath made by Japan pure chemical Co., Ltd. was used, the current density was from 2 mA/dm² to 5 mA/dm² both inclusive, and the plating rate was 5 nm/sec.

TABLE 5

| | | | | | | Anode | | |
|---|---|---|---|---|---|---|---|---|
| | | | | | | current | | |
| | | | | | | collector | | |
| | Anode active material layer | | | | | Ten point | | |
| | Anode | | | | | height of | Capacity | |
| | active | | Metal | | Void | roughness | retention | Swollenness |
| | material | | conductive | Forming | ratio | profile Rz | ratio | ratio |
| | (wt %) | | material | method | (%) | (μm) | (%) | (%) |
| Example 4-1 | Si | Fe(0.2) | Cu | Spraying | 15 | 0.5 | 58 | 1.1 |
| Example 4-2 | | | | method | | 1 | 72.3 | 1.2 |
| Example 4-3 | | | | | | 2 | 73.5 | 1.4 |
| Example 4-4 | | | Cu | Sputtering | 15 | 0.5 | 57 | 1.1 |
| Example 4-5 | | | | method | | 1 | 72.2 | 1.2 |
| Example 4-6 | | | | | | 2 | 73.3 | 1.4 |
| Example 4-7 | | | Cu | Evaporation | 15 | 0.5 | 45 | 14 |
| Example 4-8 | | | | method + plating | | 1 | 61 | 15 |
| Example 4-9 | | | | method | | 2 | 70 | 17 |
| Example 4-10 | | | Cu | Sputtering | 15 | 0.5 | 41 | 13 |
| Example 4-11 | | | | method + plating | | 1 | 59 | 14 |
| Example 4-12 | | | | method | | 2 | 68 | 16 |
| Example 4-13 | | | Cu | Spraying | 15 | 0.5 | 48 | 13 |
| Example 4-14 | | | | method + plating | | 1 | 63 | 14 |
| Example 4-15 | | | | method | | 2 | 71 | 15 |

In the case where the anode active material and the metal conductive material were formed in the same step without using impact binding phenomenon, the capacity retention ratio was significantly lower than that of the case that the anode active material and the metal conductive material were formed in the same step by using impact binding phenomenon. Further, in the case where the anode active material and the metal conductive material were formed in each individual step, the capacity retention ratio was further lower and the swollenness ratio was significantly larger than those of a case that the anode active material and the metal conductive material were formed in the same step without using impact binding phenomenon. In the case where impact binding phenomenon was not used, the void ratio did not become 10% or less under measurement conditions of a mercury porosimeter (pressure: 90 MPa) without relation to whether or not the anode active material and the metal conductive material were formed in the same step.

### Examples 5-1 to 5-7

A secondary battery was fabricated by a procedure similar to that of Example 1-3, except that crystallinity (the half bandwidth and the crystallite size of (111) crystal plane) of the anode active material were changed as illustrated in Table 6, and the cycle characteristics and the swollenness characteristics were examined. To change the crystallinity, conditions such as the deposition rate of the anode material were changed.

TABLE 6

| | Anode active material layer | | | | | | | | |
|---|---|---|---|---|---|---|---|---|---|
| | Anode active material | | | | | | | Capacity | |
| | | | Half | Crystallite | Metal | | Void | retention | Swollenness |
| | Type | | bandwidth | size | conductive | Forming | ratio | ratio | ratio |
| | (wt %) | | (degree) | (nm) | material | method | (%) | (%) | (%) |
| Example 5-1 | Si | Fe | 30 | — | Cu | PJD | 5 | 80 | 1.6 |
| Example 5-2 | | (0.2) | 23 | 5 | | method | | 80.4 | 1.6 |
| Example 5-3 | | | 20 | 10 | | | | 81.5 | 1.5 |
| Example 5-4 | | | 5 | 20 | | | | 81.6 | 1.5 |
| Example 5-5 | | | 3 | 40 | | | | 82 | 1.5 |
| Example 1-3 | | | 1 | 55 | | | | 82.5 | 1.5 |
| Example 5-6 | | | 0.7 | 100 | | | | 82.5 | 1.5 |
| Example 5-7 | | | 0.4 | 115 | | | | 82.6 | 1.5 |

A high capacity retention ratio and a small swollenness ratio were obtained not depending on the half bandwidth and the crystallite size. In particular, in the case where the anode active material was crystalline, the capacity retention ratio was further increased and the swollenness ratio was the lowest. Further, in the case where the half bandwidth was 20 degree or less and the crystallite size was 10 nm or more, the capacity retention ratio was more increased.

### Examples 6-1 to 6-8

A secondary battery was fabricated by a procedure similar to that of Example 1-3, except that the median diameter of the anode material was changed as illustrated in Table 7, and the cycle characteristics and the swollenness characteristics were examined. To change the median diameter, conditions of forming the silicon alloy were adjusted.

TABLE 7

| | Anode active material layer | | | | | | Capacity | |
|---|---|---|---|---|---|---|---|---|
| | Anode active | | Median | Metal | | Void | retention | Swollenness |
| | material | | diameter | conductive | Forming | ratio | ratio | ratio |
| | (wt %) | | (μm) | material | method | (%) | (%) | (%) |
| Example 6-1 | Si | Fe(0.2) | 0.05 | Cu | PJD | 5 | 80 | 1.5 |
| Example 6-2 | | | 0.1 | | method | | 80.5 | 1.5 |
| Example 6-3 | | | 0.5 | | | | 81.9 | 1.5 |
| Example 1-3 | | | 1 | | | | 82.5 | 1.5 |
| Example 6-4 | | | 2 | | | | 82.6 | 1.5 |
| Example 6-5 | | | 3 | | | | 83.1 | 1.5 |
| Example 6-6 | | | 5 | | | | 82.7 | 1.5 |
| Example 6-7 | | | 10 | | | | 80.9 | 1.5 |
| Example 6-8 | | | 20 | | | | 80 | 1.5 |

A high capacity retention ratio and a small swollenness ratio were obtained not depending on the median diameter. In particular, in the case where the median diameter was from 0.1 μm to 10 μm both inclusive, the capacity retention ratio was further increased.

### Examples 7-1 to 7-13

A secondary battery was fabricated by a procedure similar to that of Example 1-3, except that the composition of the anode material was changed as illustrated in Table 8, and the cycle characteristics and the swollenness characteristics were examined. To change the composition of the anode active material, the mixture ratio between silicon and a metal element was adjusted in forming the anode material.

TABLE 8

| | Anode active material layer | | | | | Capacity | |
|---|---|---|---|---|---|---|---|
| | | | Metal | | Void | retention | Swollenness |
| | Anode active material | | conductive | Forming | ratio | ratio | ratio |
| | (wt %) | | material | method | (%) | (%) | (%) |
| Example 7-1 | Si | | Cu | PJD | 5 | 81.6 | 1.5 |
| | | | | method | | | |
| Example 7-2 | Si | Fe (0.3) | | | | 82.6 | 1.5 |
| Example 7-3 | | Fe (0.5) | | | | 83.2 | 1.5 |
| Example 7-4 | | Fe (1) | | | | 83.6 | 1.5 |
| Example 7-5 | | Fe (5) | | | | 84 | 1.5 |
| Example 7-6 | | Fe (0.2) + Al (0.1) | | | | 83.2 | 1.5 |
| Example 7-7 | | Fe (0.2) + Ca (0.1) | | | | 83.4 | 1.5 |
| Example 7-8 | | Fe (0.2) + Mn (0.1) | | | | 83.3 | 1.5 |
| Example 7-9 | | Fe (0.2) + Cr (0.1) | | | | 83.6 | 1.5 |
| Example 7-10 | | Fe (0.2) + Mg (0.1) | | | | 83.4 | 1.5 |
| Example 7-11 | | Fe (0.2) + Ni (0.1) | | | | 83.6 | 1.5 |
| Example 7-12 | | Fe (0.2) + Al (0.1) + | | | | 83.7 | 1.5 |
| | | Ca (0.1) | | | | | |
| Example 7-13 | | Fe (0.3) + Al (0.2) + | | | | 84.2 | 1.5 |
| | | Ca (0.1) | | | | | |

A high capacity retention ratio and a small swollenness ratio were obtained not depending on the composition of the anode active material. In particular, as the ratio of the metal element was increased, the capacity retention ratio was further increased.

### Examples 8-1 to 8-11

A secondary battery was fabricated by a procedure similar to that of Example 1-3, except that the average thickness of the metal conductive material was changed as illustrated in Table 9, and the cycle characteristics and the swollenness characteristics were examined. To change the average thickness of the metal conductive material, deposition time (plating time) of the metal material was adjusted. In this case, the observation magnification ratio by SEM was 3000, the number of observation sheets was 5, and the number of vertical lines per one observation sheet was 1.

TABLE 9

| | Anode active material layer | | | | | | Capacity | |
|---|---|---|---|---|---|---|---|---|
| | Anode active | | Metal | Average | | Void | retention | Swollenness |
| | material | | conductive | thickness | Forming | ratio | ratio | ratio |
| | (wt %) | | material | (nm) | method | (%) | (%) | (%) |
| Example 8-1 | Si | Fe(0.2) | Cu | 0.5 | PJD | 5 | 80 | 1.6 |
| Example 8-2 | | | | 1 | method | | 80.2 | 1.5 |
| Example 8-3 | | | | 100 | | | 81.6 | 1.5 |
| Example 1-3 | | | | 200 | | | 82.5 | 1.5 |
| Example 8-4 | | | | 500 | | | 82.7 | 1.4 |
| Example 8-5 | | | | 1000 | | | 82.9 | 1.4 |
| Example 8-6 | | | | 2000 | | | 83.1 | 1.4 |
| Example 8-7 | | | | 5000 | | | 83.4 | 1.4 |
| Example 8-8 | | | | 10000 | | | 83.4 | 1.4 |
| Example 8-9 | | | | 20000 | | | 83.5 | 1.4 |
| Example 8-10 | | | | 30000 | | | 83.5 | 1.4 |
| Example 8-11 | | | | 40000 | | | 83.5 | 1.4 |

A high capacity retention ratio and a small swollenness ratio were obtained not depending on the average thickness of the metal conductive material. In particular, in the case where the average thickness was from 1 nm to 30000 nm both inclusive, a high battery capacity was also obtained.

### Examples 9-1 to 9-4

A secondary battery was fabricated by a procedure similar to that of Example 1-3, except that the cathode active material type was changed as illustrated in Table 10, and the cycle characteristics and the swollenness characteristics were examined. In this case, the lithium nickel composite oxide shown in Formula 1 was used.

TABLE 10

| | Anode active material layer | | | | | | Capacity | |
|---|---|---|---|---|---|---|---|---|
| | Anode active | | Metal | | Void | | retention | Swollenness |
| | material | | conductive | Forming | ratio | | ratio | ratio |
| | (wt %) | | material | method | (%) | Cathode active material | (%) | (%) |
| Example 9-1 | Si | Fe(0.2) | Cu | PJD | 5 | LiNi_{0.70}Co_{0.25}Al_{0.05}O₂ | 83.6 | 1.5 |
| Example 9-2 | | | | method | | LiNi_{0.79}Co_{0.14}Al_{0.07}O₂ | 83.5 | 1.5 |
| Example 9-3 | | | | | | LiNi_{0.70}Co_{0.25}Mg_{0.05}O₂ | 83.6 | 1.5 |
| Example 9-4 | | | | | | LiNi_{0.70}Co_{0.25}AlFe_{0.05}O₂ | 83.4 | 1.5 |

A high capacity retention ratio and a small swollenness ratio were obtained not depending on the cathode active material type. In particular, in the case where the lithium nickel composite oxide was used as a cathode active material, the capacity retention ratio was further improved.

### Examples 10-1 to 10-8

A secondary battery was fabricated by a procedure similar to that of Example 1-3, except that the composition of the electrolytic solution was changed as illustrated in Table 11, and the cycle characteristics and the swollenness characteristics were examined. The solvent composition (weight ratio) was as follows: 4-fluoro-1,3-dioxole-2-one (FEC):DEC=50:50, and EC:DEC:4,5-difluoro-1,3-dioxolane-2-one (DEEC)=25:70:5. The content of vinylene carbonate (VC), vinylethylene carbonate (VEC), propane sultone (PRS), sulfobenzoic anhydride (SBAH), or sulfopropionic anhydride (SPAH) in the solvent was 1 wt %. The content of the electrolyte salt to the solvent was as follows: LiPF₆=0.9 mol/kg and lithium tetrafluoroborate (LiBF₄)=0.1 mol/kg.

TABLE 11

| | | | | Capacity | Swollenness |
|---|---|---|---|---|---|
| | | | | retention ratio | ratio |
| | Solvent | | Electrolyte salt | (%) | (%) |
| Example 1-3 | EC + DEC | | LIPF₆ | 82.5 | 1.5 |
| Example 10-1 | FEC + DEC | | | 83.6 | 1.5 |
| Example 10-2 | EC + DEC + DFEC | | | 84.1 | 1.5 |
| Example 10-3 | FEC + DEC | VC | | 84 | 1.5 |
| Example 10-4 | | VEC | | 84.1 | 1.5 |
| Example 10-5 | | PRS | | 83.2 | 1.5 |
| Example 10-6 | | SBAH | | 83.3 | 1.3 |
| Example 10-7 | | SPAH | | 83.2 | 1.2 |

| | | | | |
|---|---|---|---|---|
| Example 10-8 | FEC + DEC | LIPF₆ + LIBF₄ | 83.4 | 1.3 |

A high capacity retention ratio and a small swollenness ratio were obtained not depending on the composition of the electrolytic solution. In particular, in the case where other solvent (halogenated cyclic ester carbonate or the like) or the electrolyte salt (LiBF₄) was used, the capacity retention ratio was further improved.

### Examples 11-1 and 11-2

A secondary battery was fabricated by a procedure similar to that of Example 1-3, except that the battery structure was changed as illustrated in Table 12, and the cycle characteristics were examined. In fabricating the square type secondary battery, an aluminum battery can or an iron battery can was used.

TABLE 12

| | | Capacity retention | Swollenness |
|---|---|---|---|
| | Battery structure | ratio (%) | ratio (%) |
| Example 1-3 | Laminated film type | 82.5 | 1.5 |
| Example 11-1 | Square type (Al) | 83.2 | 1.3 |
| Example 11-2 | Square type (Fe) | 84.5 | 1.1 |

A high capacity retention ratio and a small swollenness ratio were obtained not depending on the battery structure. In particular, in the case where the battery structure was the square type, and more specifically, in the case where the battery can was made of iron, the capacity retention ratio was further increased, and the swollenness ratio was further decreased.

From the results of Table 1 to Table 12, it is derived as follows. That is, in the invention, in the case where the anode active material layer contains the anode active material (having silicon as an element) and the metal conducive material, the void ratio of the anode active material layer measured by mercury intrusion method (pressure: 90 MPa) is 10% or less. Thereby, the cycle characteristics and the swollenness characteristics are improved not depending on conditions such as the forming material of the anode active material and the metal conductive material and the composition thereof.

The invention has been described with reference to the embodiment and the examples. However, the invention is not limited to the aspects described in the foregoing embodiment and the foregoing examples, and various modifications may be made. For example, the description has been given of the case that the anode capacity is expressed based on inserting and extracting lithium ions. However, the secondary battery of the invention is not limited thereto. The invention is able to be similarly applied to a secondary battery in which the anode capacity includes the capacity due to inserting and extracting lithium ions and the capacity due to precipitation and dissolution of lithium metal, and the anode capacity is expressed by the sum of these capacities. In this case, an anode material capable of inserting and extracting lithium ions is used as an anode active material, and the chargeable capacity of the anode material is set to a smaller value than the discharge capacity of the cathode.

Further, the description has been given of the case in which the battery structure is the square type, the cylindrical type, or the laminated film type, and of the case in which the battery element has the wound structure. However, the battery structure is not limited thereto, but the invention is able to be similarly applied to a case that the battery structure is a button type, or a case that the battery element has a laminated structure or the like.

The present application contains subject matter related to that disclosed in Japanese Priority Patent Application JP 2010-015738 filed in the Japan Patent Office on Jan. 27, 2010, the entire contents of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. A method of forming an anode, comprising:
providing a mixture of anode active material particles and a conductive material using an atomization process, the mixture having a ratio of the anode active material to the metal material; and
depositing the mixture on a surface of a anode current collector by impact binding and causing at least some of the anode active material particles, at least some of the conductive material, or both to be linked to the anode current collector.

2. The method of claim 1, wherein the mixture is an alloy powder.

3. The method of claim 1, wherein the mixture comprises anode material powder and metal material powder.

4. The method of claim 1 wherein the atomization method is a gas atomization method.

5. The method of claim 1, wherein the atomization method is a water atomization method.

6. The method of claim 1, wherein the anode active material layer comprises (a) anode active material particles including silicon, a median diameter of the anode active material particles being from 0.1 μm to 10 μm, both inclusive, and (b) a metal conductive material separate from but intermixed with the anode active material particles and including at least one metal selected from the group consisting of copper, nickel, cobalt, iron, zinc, aluminum, chromium, manganese, titanium, zirconium, molybdenum, tungsten, silver, indium, calcium, magnesium, and potassium.

7. The method of claim 1, wherein the anode active material particles and the conductive material are simultaneously deposited by a powder jet deposition method, an aerosol deposition method, or both.

8. The method of claim 1, wherein a resulting anode active material layer on the current collector has a void ratio as measured by a mercury intrusion method (pressure: 90 MPa) of 10% or less.

9. The method of claim 8, where the resulting anode active material layer on the current collector has a void ratio of 7% or less.

10. The method of claim 1, wherein the conductive material is a simple metal substance, a metal alloy, a metal compound, or any combination of the foregoing.

11. The method of claim 10, wherein the conductive material is a simple metal substance.

12. The method of claim 1, wherein the anode active material particles are a simple substance of silicon, an alloy of silicon, a compound of silicon, or any combination of the foregoing.

13. The method of claim 1, wherein the conductive material is selected from the group consisting of iron, aluminum, calcium, manganese, chromium, magnesium, nickel, potassium, copper, and titanium.

14. The method of claim 1, wherein the anode active material particles are crystalline.

15. The method of claim 1, wherein a half bandwidth (2θ) of a diffraction peak in (111) crystal plane of the anode active material particles obtained by X-ray diffraction is 20 degree or less, and a crystallite size is 10 nm or more.

16. The method of claim 1, wherein the anode active material particles, the metal conductive material, or both are caused to be alloyed with the anode current collector.

17. The method of claim 1, wherein a ten point height of roughness profile Rz of a surface of the anode current collector is 2 μm or less.

18. The method of claim 1, wherein the ten point height of roughness profile Rz is 1 μm or less.

19. The method of claim 1, wherein the anode active material layer does not contain a binder.
